(19) United States
(12) Patent Application Publication
(10) Pub. No.: US 2011/0077365 A1
(43) Pub. Date: Mar. 31, 2011

(54) PREPARATION OF ORGANOSILICON-CONTAINING TRIAZOLES

(76) Inventors: Gilbert Yu, Quezon City (PH); Ferdinand Gonzaga, Hamilton (CA); Michael A. Brook, Ancaster (CA)

(21) Appl. No.: 12/648,395

(22) Filed: Dec. 29, 2009

Related U.S. Application Data
(60) Provisional application No. 61/141,007, filed on Dec. 29, 2008.

(51) Int. Cl. C08G 77/388; C07F 7/10; C08G 77/26

(52) U.S. Cl. 525/479; 548/110; 528/38

(57) ABSTRACT

The disclosure includes methods for preparing organosilicon-containing 1,2,3-triazoles by reacting an organosilicon containing azide with an alkyne compound or an organosilicon containing alkyne with an azide compound under thermal reaction conditions.

### RELATED APPLICATIONS

This application claims the benefit of 35 USC §119 based on the priority of co-pending U.S. Provisional Patent Application 61/141,007, filed Dec. 29, 2008, the contents of which are incorporated herein in their entirety by reference.

### FIELD OF THE DISCLOSURE

The disclosure relates to methods of forming triazoles via 1,3-cycloaddition reactions. In particular the methods are applied to organosilicon compounds, including methods of functionalizing and crosslinking polymeric species such as silicones.

### BACKGROUND OF THE DISCLOSURE

Silicones or polysiloxanes are a class of polymers known for their broad utility in commerce. These uses arise from their properties, which are generally unattainable by organic polymers. Such properties include hydrophobicity, surface activity, thermal and electrical stability, and biocompatibility among others. Silicones are initially prepared as low molecular weight linear and cyclic polymers, which are then finished into molecular weight oils. Higher value products arise when the materials are modified by organic groups, which lead to improvements in product performance, or by crosslinking.

Functional silicones exhibit a variety of beneficial properties. Complex side chains give enhanced properties to silicones for various uses such as liquid crystals, antifoaming agents, antistatic agents, and textile finishing agents.¹ Poly(ethylene oxide) (PEO) functionalized silicones, for example, give interesting surfactant properties.¹⁻³ Such compounds, for example, DC3225c from Dow Corning, and related products from Wacker, Shinetsu, Momentive, Blue Star, and others, can be used to stabilize bubbles in polyurethane foam. Silicone biomolecule conjugates including silicone-carbohydrates⁴⁻⁶ and silicone-protein⁷⁻⁹ linkages have also been investigated.

A wide variety of functional groups may be introduced to silicones, most of which are prepared from gamma functional propyl or alpha functional alkyl groups. The former are normally prepared by hydrosilylation of a functional propene (R₃SiH+H₂C═CH—CH₂FG (FG=functional group) →R₃Si(CH₂)₃FG, where R₃Si is a silane or silicone-based residue). The latter compounds are generally prepared from appropriate functional silanes synthesized by the chlorination of methylsilanes, followed by substitution to introduce the desired functionality (R₃SiMe→R₃SiCH₂Cl→R₃SiCH₂FG). In this case, the conversion from chloro to other functional groups may optionally be done at the silane stage, or after the compound has been converted into a silicone. The functional groups so introduced include organic functional groups such as alcohols, epoxides, esters, amines, thiols, etc. Once functionalized, the materials may then be polymerized to give homo- or mixed silicone polymers (see Scheme 1, shown for cyclic D₃ derivatives—other linear and cyclic oligomers may also be used).

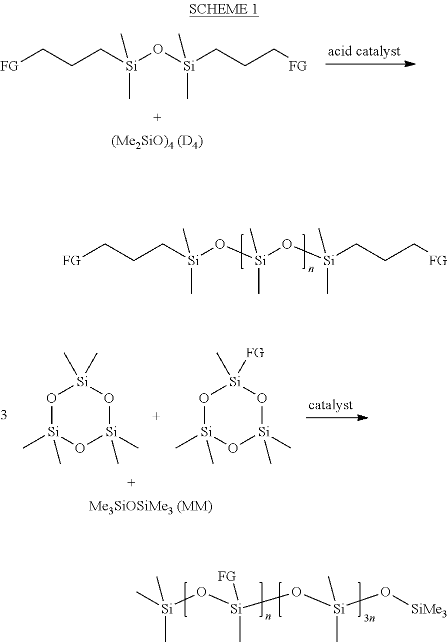

Although several other methods to functionalize silicones have been established, these processes usually involve a series of protection and deprotection steps, as in the case of carbohydrate-functionalized silicones.⁴⁻⁶ It can be synthetically challenging to introduce the desired functional groups on existing silicone polymers and, therefore, reactions are frequently performed on small molecules that are then ‘finished’ into functional silicone polymers.

The other higher value silicone materials noted above are elastomeric in nature. Three routes are typically used commercially to create silicone elastomers: platinum catalyzed addition cure, tin or titanium catalyzed room temperature vulcanization (RTV, moisture cure), or radical cure, which is frequently performed at higher temperatures. All three methods of cure suffer from some deficiencies. These include use of expensive metals such as platinum, the formation of elastomers that contain metal residues which can leach from the elastomer, and/or difficulties in processing the elastomer during and after cure.

Amphiphilic polymer co-networks (APCNs) are a novel class of polymeric materials, composed of hydrophilic and hydrophobic segments, covalently interlinked into a 3D structure. A variety of structural morphologies can exist in such materials. For example, use of appropriate molecular weights of the different segments can lead to nanophase separation into hydrophilic and the other hydrophobic domains. The presence of two opposite phases in a single material permits control of a wide range of properties, as each phase can independently interact with molecules or solvents of like polarity. For example, the interaction of hydrophilic segments with water will lead to swelling of the material (analogously, the hydrophobic parts could be swollen by apolar organic solvents). This ability to interact with solvents or solutes of opposite polarities makes APCNs ideal candidates for a number of applications, including soft contact lenses, tissue engineering scaffolds, drug release matrices, pervaporation membranes, biochemical sensors, phase-transfer catalysts, selective extractants, temperature-activated actuators, supports for enzyme immobilization, synthesis of mesoporous silica and growth of semiconducting nanocrystals, among others. The development of synthetic strategies for and characterization techniques of APCNs is thus the focus of considerable attention from the polymer chemist community.

A variety of cycloaddition reactions occur between π-systems of various types. For example, the Diels-Alder reaction leads to the formation of cyclic systems by the thermally assisted combination of a diene and an alkene: other 4π+2π electron combinations have also been described. This process has been used to functionalize polymeric materials, including the modification of small silicones with amino acids.⁹ More recently, there has been utilization of the Huisgen 1,3-dipolar cycloaddition of azides to alkynes to functionalize organic molecules, including polymers.¹⁰ The reaction, a so called “Click” reaction, is a robust and reliable method for the functionalization of a wide variety of molecules because its sole product, the triazole ring, acts as a stable linker between the two precursors.¹¹⁻¹⁴ The reaction is generally performed with the use of a copper (I) catalyst and this process has been used to prepare saccharide-functional silicones.¹⁵ The copper(I) catalyzed Huisgen cycloaddition has become the best known and most broadly used “Click” reaction,^{13,16-25} however, the process is disadvantageous because of the need for the use of copper, which could subsequently leach from the silicone matrix: copper compounds can be toxic.

Click chemistry has been used in polymer chemistry.^{10, 29} Azidopropylsilanes have been reported in the patent literature³⁰ and, in a single case, copper catalyzed Click chemistry has been reported with silicones.¹⁵

### SUMMARY OF THE DISCLOSURE

Herein is described simple, efficient, catalyst-free systems to prepare organosilicon compounds, including both functionalized and/or crosslinked silicon polymers. In addition, these systems allow one to choose to functionalize or crosslink silicon polymers neat, in organic solvents, or in water.

It has unexpectedly been found that the reaction between an organosilicon-containing azide, including silicon polymers, and an alkyne, including alkyne-containing polymers, takes place below the decomposition point of the azide without the use of a catalyst. In the alternative, the one or more alkynes are on the organosilicon compound, including an organosilicon polymer, which is reacted with a compound comprising at least one azide group, including azide-containing polymers, to provide the corresponding cyclic triazole compounds. This allows for the preparation of organosilicon-containing triazoles under safe and catalyst-free conditions.

Accordingly, in one aspect, the present disclosure includes a method for preparing organosilicon-containing triazoles comprising reacting:
(i) an organosilicon compound comprising at least one azide group with a compound comprising at least one alkyne group; or
(ii) an organosilicon compound comprising at least one alkyne group with a compound comprising at least one azide group
under thermal reaction conditions in the absence of a catalyst.

Accordingly, in one aspect, the present disclosure includes a method for preparing a compound of formula (Ia) and/or (Ib)

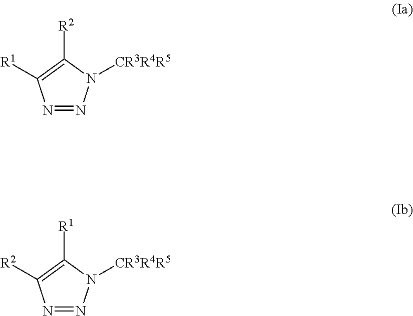

comprising reacting a compound of the formula (II) with a compound of the formula (III):

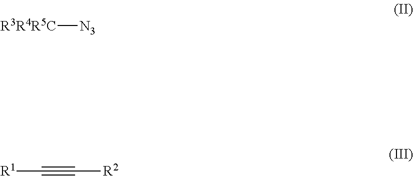

wherein R¹, R², R³, R⁴ and R⁵ are, independently, any organic grouping and at least one of R¹, R², R³, R⁴ and R⁵ comprises at least one silicon atom, under thermal reaction conditions in the absence of a catalyst.

In particular it was found that a 1,3-dipolar cycloaddition reaction between an azido silicon polymer and a compound comprising at least one alkynyl group can be carried out in the absence of a metal catalyst. It was also found that azido-modified silicon polymer systems will undergo both functionalization and crosslinking processes using thermal conditions, again without a catalyst. The method of the disclosure can be used, for example, to prepare organofunctional silicon-containing polymers, silicon-containing polymers with block or graft structures, or crosslinked silicon-containing polymers.

Accordingly, in an embodiment of the present disclosure, there is included a method for preparing organosilicon-containing polymers containing one or more triazoles comprising reacting:
(i) an organosilicon-containing polymer comprising at least one azide group with a compound comprising at least one alkyne group; or
(ii) an organosilicon-containing polymer comprising at least one alkyne group with a compound comprising at least one azide group, under thermal reaction conditions in the absence of a catalyst.

In an embodiment of the disclosure, the organosilicon-containing polymer is a silicone, accordingly, there is included a method for preparing a silicone polymer comprised of repeating monomer units of the formulae (IVa) and (IVb) and/or (IVc):

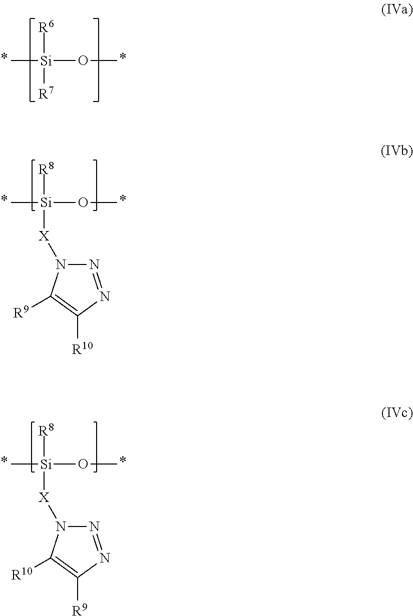

the method comprising reacting a silicone polymer comprised of repeating monomer units of the formulae (IVa) and (V) with a compound of the formula (VI):

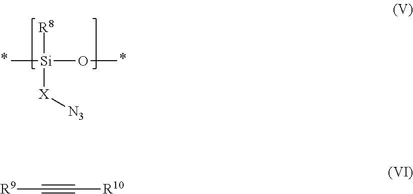

wherein R⁶, R⁷, R⁸, R⁹ and R¹⁰ are, independently, any organic grouping;
X is selected from, C₁₋₂₀alkylene, which is optionally substituted with one or more organic groupings and/or in which one or more carbon atoms is optionally replaced with an arylene, a heteroatom and/or —C(O)— wherein Q is a heteroatom; and
* represents a linkage to another monomer unit or to a terminal grouping, under thermal reaction conditions in the absence of a catalyst.

In an alternative embodiment of the disclosure, there is included a method for preparing a silicone polymer comprised of repeating monomer units of the formulae (VIIa) and (VIIb) and/or (VIIc)

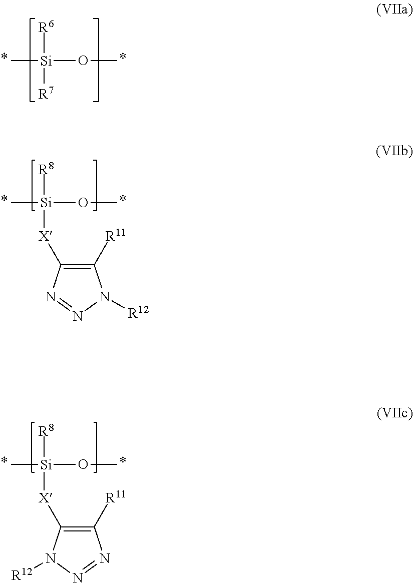

the method comprising reacting a silicone polymer comprised of monomer units of the formulae (VIIa) and (VIII) with a compound of the formula (IX):

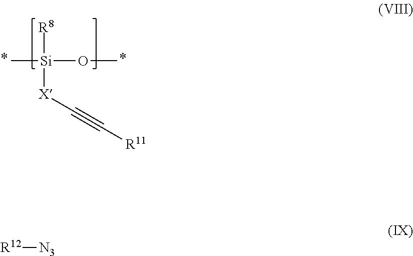

wherein R⁶, R⁷, R⁸, R¹¹ and R¹² are, independently, any organic grouping;

X′ is selected from, C₀₋₂₀alkylene which is optionally substituted with one or more organic groupings and/or in which one or more carbon atoms is optionally replaced with an arylene, a heteroatom and/or C(Q) wherein Q is a heteroatom; and

* represents a linkage to another monomer unit or to a terminal grouping, under thermal reaction conditions in the absence of a catalyst.
In a further embodiment, the formation of the triazole leads to a cross-link between two polymers. In this embodiment, R⁹ and/or R¹⁰ in the compounds of Formula (VI) comprise one or more alkynyl groups or R¹² in the compounds of Formula (IX) comprise one or more azide groups.

The present disclosure also includes an example of an APCN based on hydrophilic segments, for example poly(ethylene oxide) (PEO) segments, and hydrophobic polysiloxanes that is prepared by crosslinking using the method of the present disclosure. For example, in a first step, the process involves the combination of mono- or di-propiolate esters of commercially available hydrophilic segments, such as PEOs, with graft-poly(azidopropylmethylsiloxane-co-dimethylsiloxane), or, in an alternate complementary strategy, the combination of mono- or di-azidoterminated hydrophilic segments, such as PEOs, with a graft-poly((methyl)alkynoate ester)siloxane-co-dimethylsiloxane) copolymer. In the two synthetic strategies, cross-linking of the different segments occurred via the formation of triazole rings, in a metal catalyst-free Click (Huisgen) cycloaddition. The process benefited from the increased reactivity of propiolate esters, when compared to non-conjugated alkynes, which allowed the Click reaction to be performed slowly at room temperature, or more rapidly at higher temperatures. By varying the molecular weight and also the ratio of mono- versus di-propiolate esters of the hydrophilic segments, easy access to chemically different APCNs is provided. This new approach allowed the preparation of metal-free, transparent, amphiphilic elastomers having highly-controlled hydrophobic/hydrophilic balance.

The present disclosure also includes a compound prepared using the methods of the disclosure. Accordingly, the present disclosure includes a compound of formula (Ia) and/or (Ib):

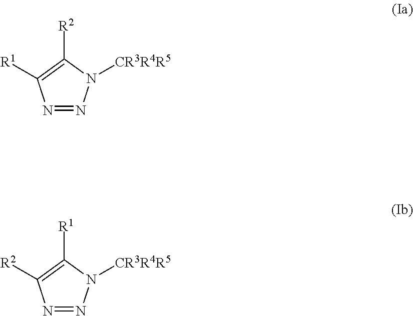

wherein R¹, R², R³, R⁴ and R⁵ are, independently, any organic grouping and at least one of R¹, R², R³, R⁴ and R⁵ comprises at least one silicon atom.

Also included in the present disclosure is a silicone polymer comprised of repeating monomer units of the formulae (IVa) and (IVb) and/or (IVc):

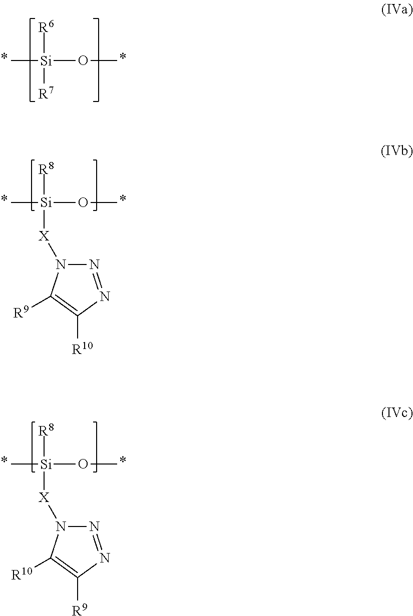

wherein R⁶, R⁷, R⁸, R⁹ and R¹⁰ are, independently, any organic grouping;
X is selected from, C₁₋₂₀alkylene, which is optionally substituted with one or more organic groupings and/or in which one or more carbon atoms is optionally replaced with an arylene, a heteroatom and/or —C(Q)- wherein Q is a heteroatom; and
* represents a linkage to another monomer unit or to a terminal grouping.

Also included in the present disclosure is a silicone polymer comprised of repeating monomer units of the formulae (VIIa) and (VIIb) and/or (VIIc):

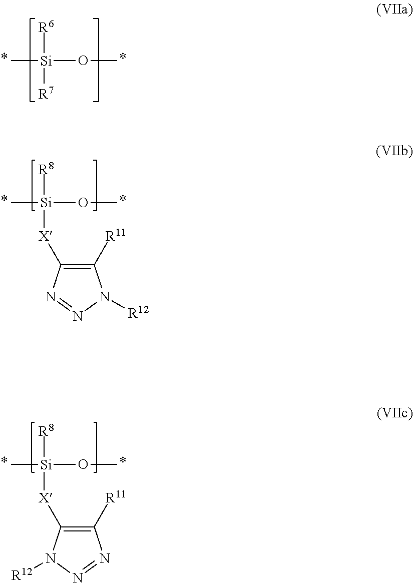

wherein R⁶, R⁷, R⁸, R¹¹ and R¹² are, independently, any organic grouping;
X′ is selected from, C₀₋₂₀alkylene which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping.

Other features and advantages of the present disclosure will become apparent from the following detailed description. It should be understood, however, that the detailed description and the specific examples while indicating preferred embodiments of the disclosure are given by way of illustration only, since various changes and modifications within the spirit and scope of the disclosure will become apparent to those skilled in the art from this detailed description.

### BRIEF DESCRIPTION OF THE DRAWINGS

The disclosure will now be described in relation to the drawings in which:

FIG. 1A shows a Thermogravimetric Analysis (TGA) of 1,3-bis(azidopropyl)tetramethyldisiloxane (BAPTMDS); and

FIG. 1B shows a Thermogravimetric Analysis (TGA) of a polyazidopropylsilicone.

### DETAILED DESCRIPTION OF THE DISCLOSURE

### (I) Definitions

The expression “silicon-containing polymer” as used herein means any silicon-containing polymer, i.e. a polymer comprised of two or more monomeric units, wherein at least one monomeric unit comprises at least one silicon atom. In an embodiment, the silicon polymer is a silicone. Silicone is a polymer having repeating monomeric units of the formula:

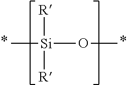

wherein each R′ in the same monomeric unit and in adjacent monomeric units are the same or different and each represent an organic grouping. The silicon containing polymer can have linear, cyclic, branched or crosslinked structure.

The term “organic grouping” as used herein means any carbon-based radical, including those where one or more carbon atoms, but not all, are replaced with a heteroatom. Organic groupings may be fully saturated, partially saturated, or aromatic (aryl). Organic groupings include straight and branched chains as well as cyclic structures including those with one or more rings linked together by a single or double bond, or in a fused, bridged, and spiro cyclic fashion. The organic groupings may be of the small molecule type, for example comprising 1 to 30 atoms, 2-30 atoms for unsaturated groupings and 3 to 30 atoms for cyclic groupings, or they may be polymeric in nature, for example, but not limited to polysaccharides, polyolefins, polyesters, polyethers, polyurethanes, polyamides, proteins, peptides, nucleic acids and silicones. Organic groupings include, but are not limited to, functional groupings such as alkyl, alkenyl, alkynyl, aryl, heteroaryl, cycloalkyl, cycloalkenyl, heterocyclyl, heterocycloalkenyl, ethers, esters, amides, carboxyls, imides, imines and hydrazines. One or more hydrogen atoms on an organic grouping may also be “substituted” for example, but not limited to, by one or more halogens (Cl, F, Br, or I), ═O, ═S, ═NH, OH, NH₂, NO₂, SH, SO₃H, PO₃H₂ and the like.

The term “alkyl” as used herein, whether it is used alone or as part of another group, means straight or branched chain, saturated alkyl groups. It is an embodiment of the application that the alkyl groups are optionally substituted. It is a further embodiment that, in the alkyl groups, one or more, including all, of the hydrogen atoms are optionally replaced with F and thus includes, for example, trifluoromethyl, pentafluoroethyl and the like.

The term “alkenyl” as used herein, whether it is used alone or as part of another group, means straight or branched chain, unsaturated alkyl groups, i.e., alkyl groups that contain one or more double bonds. It is an embodiment of the application that the alkenyl groups are optionally substituted. It is a further embodiment that, in the alkenyl groups, one or more, including all, of the hydrogen atoms are optionally replaced with F and thus includes, for example, trifluoroethenyl and the like.

The term “alkynyl” as used herein, whether it is used alone or as part of another group, means straight or branched chain, unsaturated alkyl groups, i.e., alkynyl groups that contain one or more triple bonds. It is an embodiment of the application that the alkynyl groups are optionally substituted. It is a further embodiment that, in the alkynyl groups, one or more, including all, of the hydrogen atoms are optionally replaced with F.

The term “aryl” as used herein refers to cyclic groups that contain at least one aromatic ring. The cyclic groups are either monocyclic, bicyclic or tricyclic, and, when more than one ring is present, the rings are joined in fused, spiro and/or bridged arrangements. In an embodiment of the application, the aryl group contains from 6 to 14 atoms. It is an embodiment of the application that the aryl groups are optionally substituted. It is a further embodiment that, in the aryl groups, one or more, including all, of the hydrogen atoms are optionally replaced with F and thus includes, for example, pentafluorophenyl and the like.

The term “heteroaryl” as used herein means a monocyclic or polycyclic ring system containing one or two aromatic rings and from 5 to 14 heteromoieties of which, unless otherwise specified, one, two, three, four or five are independently selected from O, S, N, NH, NC₁₋₆alkyl, N(O), SiH, SiC₁₋₆alkyl and Si(C₁₋₆alkyl)₂ and includes thienyl, furyl, pyrrolyl, pyrididyl, indolyl, quinolyl, isoquinolyl, tetrahydroquinolyl, benzofuryl, benzothienyl and the like.

The term “cycloalkyl” as used herein means a monocyclic or polycyclic saturated carbocylic group and includes cyclopropyl, cyclobutyl, cyclopentyl, cyclodecyl, bicyclo[2.2.2]octane, bicyclo[3.1.1]heptane. It is an embodiment of the application that the cycloalkyl groups are optionally substituted. It is a further embodiment that, in the cycloalkyl groups, one or more, including all, of the hydrogen atoms are optionally replaced with F.

The term “ring system” as used herein refers to a carbon-containing ring system, that includes monocycles and polycyclic rings. Where specified, the carbons in the rings may be substituted or replaced with heteroatoms. Ring systems include saturated, unsaturated or aromatic rings, or combinations thereof.

The term “polycyclic” as used herein means groups that contain more than one ring linked together and includes, for example, groups that contain two (bicyclic), three (tricyclic) or four (quadracyclic) rings. The rings may be linked through a single bond, a single atom (spirocyclic) or through two atoms (fused and bridged).

The term “halo” as used herein refers to a halogen atom and includes F, Cl, Br and I.

The term “residue of a natural amino acid” refers to the substituent “R” group on one of the 20 naturally occurring amino acids.

The terms “protective group” or “protecting group” or “PG” or the like as used herein refer to a chemical moiety which protects or masks a reactive portion of a molecule to prevent side reactions in those reactive portions of the molecule, while manipulating or reacting a different portion of the molecule. After the manipulation or reaction is complete, the protecting group is removed under conditions that do not degrade or decompose the remaining portions of the molecule. Many conventional protecting groups are known in the art, for example as described in “Protective Groups in Organic Chemistry” McOmie, J. F. W. Ed., Plenum Press, 1973, in Greene, T. W. and Wuts, P. G. M., “Protective Groups in Organic Synthesis”, John Wiley & Sons, 3^{rd} Edition, 1999 and in Kocienski, P. Protecting Groups, 3rd Edition, 2003, Georg Thieme Verlag (The Americas). Examples of suitable protecting groups include but are not limited to t-BOC, Ts, Ms, TBDMS (or TBS), TBDPS, Tf, Bn, allyl, Fmoc, C₁₋₁₆acyl and the like. In certain embodiments, the protecting group is a cyclic protecting group formed by linking two adjacent functional groups, for example, adjacent hydroxyl groups. An example of a cyclic protecting group is a cyclic acetal or ketal, such as dimethyl acetal.

The term “optionally substituted” as used herein means that the referenced group is unsubstituted or substituted with one or more groups that are compatible with the reaction conditions utilized herein and do not impede, but may actually promote, the reaction processes. In an embodiment, the optional substituents are one or more, one to five, one to four, one to three, one to two or one of those substitutent groups that are specified for a particular group. In an embodiment, the substituent groups are for example, but not limited to, one or more halogens (Cl, F, Br, or I), ═O, ═S, ═NH, OH, NH₂, NO₂, SH, SO₃H, PO₃H₂ and the like.

The term “suitable”, as in for example, “suitable protecting group”, “suitable leaving group” or “suitable reaction conditions” means that the selection of the particular group or conditions would depend on the specific synthetic manipulation to be performed, and the identity of the molecule to be transformed, but the selection would be well within the skill of a person trained in the art. All process steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

t-BOC as used herein refers to the group t-butyloxycarbonyl.

Ac as used herein refers to the group acetyl.

Ts (tosyl) as used herein refers to the group p-toluenesulfonyl

Ms as used herein refers to the group methanesulfonyl

TBDMS (TBS) as used herein refers to the group t-butyldimethylsilyl.

TBDPS as used herein refers to the group t-butyldiphenylsilyl.

Tf as used herein refers to the group trifluoromethanesulfonyl.

Ns as used herein refers to the group naphthalene sulfonyl.

Bn as used herein refers to the group benzyl.

Fmoc as used here refers to the group fluorenylmethoxycarbonyl.

The term “terminal grouping” as used herein refers to the terminal group on a polymer. In an embodiment the terminal grouping on a silicon polymer is of the formula —SiR^{a}R^{b}R^{c}, where R^{a}, R^{b} and R^{c} are the same or different and are C₁₋₁₀alkyl.

The term “heteroatom” as used herein means S, O, N, Si and P, and where required by valency, the heteroatom may be substituted with one or more H or organic groupings.

In some cases the methods outlined herein may have to be modified, for instance by use of protecting groups, to prevent side reactions of reactive groups attached as substituents. This may be achieved by means of conventional protecting groups, for example as described in “Protective Groups in Organic Chemistry” McOmie, J. F. W. Ed., Plenum Press, 1973 and in Greene, T. W. and Wuts, P. G. M., “Protective Groups in Organic Synthesis”, John Wiley & Sons, 3^{rd} Edition, 1999.

The term “Click reaction” or “Click chemistry” as used herein refers to the 1,3-dipolar cycloaddition reaction between a compound comprising at least one azide group with a compound comprising at least one alkyne group to provide a 1,2,3-trizole-containing compound. This reaction is also known as the Huisgen cycloaddition reaction.

The term “alkyne” as used herein means the chemical grouping “—C≡C—”.

The term “azide” as used herein means the chemical grouping “—N₃”.

The term “triazole” as used herein means the chemical grouping

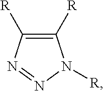

wherein each R group may be the same or different.

The term “thermal reaction conditions” as used herein means to react two or more compounds together at a suitable temperature, suitably at a temperature up to about 10° C. below the thermal decomposition temperature of the azide, in the absence of a catalyst and optionally in a suitable solvent. A person skilled in the art would understand that thermal reaction conditions may be varied depending on the structures of the starting reagents. For example, the reaction temperature is suitably the lowest reaction temperature that provides the highest yields and the solvent, if used, is suitably any solvent in which the starting reagents are at least partially soluble and that does not interfere or otherwise inhibit the reaction.

The term “catalyst” as used herein means a separate reagent added to the reaction, typically in sub-stoichiometric amounts, such that its presence in the reaction mixture results in an increase in the reaction rate and/or product yield as compared to the same reaction performed in the absence of the reagent. With respect to the Huisgen 1,3-dipolar cycloaddition reaction (or “Click” reaction) between an azide and an alkyne, the catalyst is typically a metal, for example a copper (I) or Cu(II) compound.

The term “hydroxy-substituted” as used herein means that the referenced group is substituted with one or more hydroxyl (“OH”) groups. Hydroxy-substituted-C₁₋₂₀alkyl includes alkyl groups wherein each carbon atom is substituted with one hydroxy group.

The terms “a” and “an” means “one” or “one or more”.

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The definitions and embodiments described in particular sections are intended to be applicable to other embodiments herein described for which they are suitable as would be understood by a person skilled in the art.

### (II) Methods of the Disclosure

Azide-pendant and terminal-terminated siloxanes and silicones were thermally coupled using 1,3-dipolar cycloadditions with various alkynes. It was shown that such a method provides very high yields and that the method was efficient for both hydrophilic and hydrophobic, polymeric and non-polymeric alkynes. The reaction could be performed in heterogeneous conditions, and easily yielded triazole-containing products which would be otherwise difficult if not impossible to prepare with traditional methodologies. Both non-polymeric and polymeric azides were used for these functionalization and crosslinking processes under thermal conditions in the absence of solvent or in a variety of solvents. Conversely, alkyne-functionalized siloxanes and silicones were coupled with various polymeric and non-polymeric azides to obtain the same types of coupled triazole-containing products.

Specifically, it was observed that azidoalkylsiloxanes, such azido-terminated siloxane, BAPTMDS, or pendant azidopropyl-modified silicone polymers, undergo efficient and rapid Click ligation with a variety of alkynes, including both hydrophilic and hydrophobic moieties. The metal free process occurs under thermal reaction conditions in organic solvents, water or neat, and leads to functional fluids, or crosslinked structures.

Accordingly, in one aspect, the present disclosure includes a method for preparing organosilicon-containing triazoles comprising reacting:
(i) an organosilicon compound comprising at least one azide group with a compound comprising at least one alkyne group; or
(ii) an organosilicon compound comprising at least one alkyne group with a compound comprising at least one azide group
under thermal reaction conditions in the absence of a catalyst.

In an embodiment of the present disclosure there is included a method for preparing an organosilicon-containing triazole by reacting an organosilicon compound comprising at least one azide group with a compound comprising at least one alkyne group under thermal reaction conditions in the absence of a catalyst.

In a further embodiment, the organosilicon-containing azide is a silane wherein the silicon is separated from the azide group by 1-20 carbon atoms. In a further embodiment, the organosilicon-containing azide is a polymeric silane, suitably a silicone.

In a further embodiment of the present disclosure, the at least one alkyne group is an electron deficient alkyne. For example, an alkyne that is substituted with one or two electron-withdrawing groups such as, but not limited to, C(Y)—Z—R^{a}, wherein R^{a} is an organic grouping or a halogen selected from I, Cl, Br and F, Y is O, N, NH or S and Z is O, S, N, NH, or a bond.

In a further embodiment of the present disclosure, the azide and the alkyne are located on the same molecule and the reaction results in the intramolecular and/or intermolecular formation of a triazole.

In a specific aspect of the present disclosure, there is included a method for preparing a compound of formula (Ia) and/or (Ib)

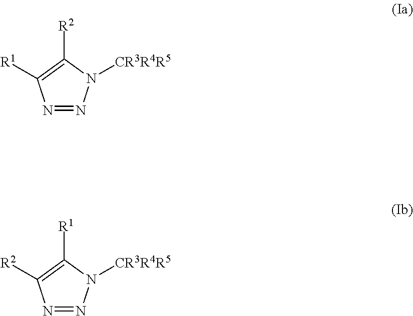

the method comprising reacting a compound of the formula (II) with a compound of the formula (III):

R³R⁴R⁵C—N₃ (II)

R¹—═—R² (III)

wherein R¹, R², R³, R⁴ and R⁵ are, independently, any organic grouping and at least one of R¹, R², R³, R⁴ and R⁵ comprises at least one silicon atom,
under thermal reaction conditions in the absence of a catalyst.

In a further embodiment of the present disclosure, there is included a method for preparing organosilicon polymers containing one or more triazoles comprising reacting:
(i) an organosilicon polymer comprising at least one azide group with a compound comprising at least one alkyne group; or
(ii) an organosilicon polymer comprising at least one alkyne group with a compound comprising at least one azide group,
under thermal reaction conditions in the absence of a catalyst.

In a specific embodiment of the present disclosure the method for preparing organosilicon polymers containing one or more triazoles comprises reacting an organosilicon polymer comprising at least one azide group with a compound comprising at least one alkyne group under thermal reaction conditions in the absence of a catalyst.

In an embodiment of the disclosure, the organosilicon polymer is a silicone, accordingly, there is included a method for preparing a silicone polymer comprised of monomer units of the formulae (IVa) and (IVb) and/or (IVc):

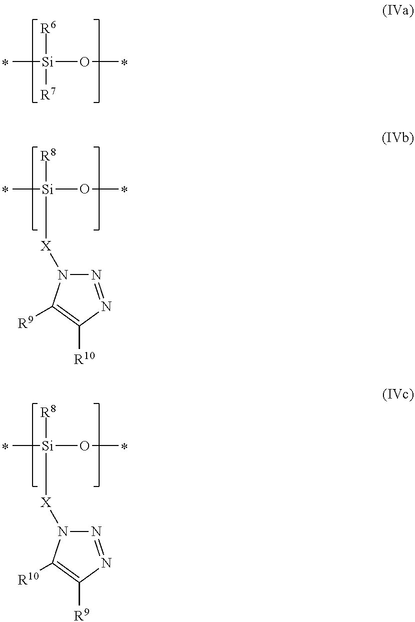

the method comprising reacting a silicone polymer comprised of monomer units of the formulae (IVa) and (V) with a compound of the formula (VI):

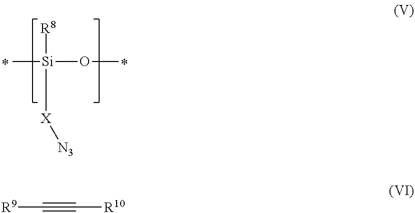

wherein R⁶, R⁷, R⁸, R⁹ and R¹⁰ are, independently, any organic grouping;
X is selected from, C₁₋₂₀alkylene, which is optionally substituted with one or more organic groupings and/or in which one or more carbon atoms is optionally replaced with an arylene, a heteroatom and/or —C(Q)- wherein Q is a heteroatom; and
* represents a linkage to another monomer unit or to a terminal organic grouping, under thermal reaction conditions in the absence of a catalyst.

In an alternative embodiment of the disclosure, there is included a method for preparing a silicone polymer comprised of monomer units of formulae (VIIa) and (VIIb) and/or (VIIc)

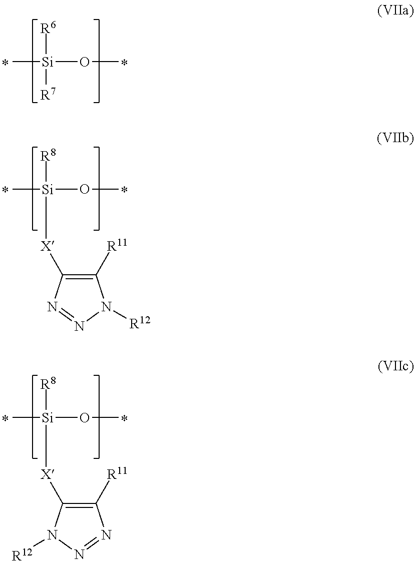

the method comprising reacting a silicone polymer comprised of monomer units of the formulae (VIIa) and (VIII) with a compound of the formula (IX):

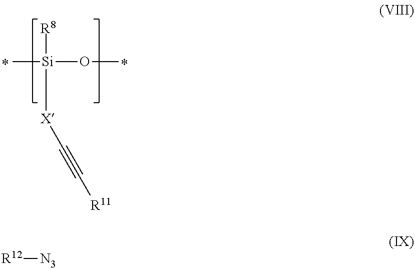

wherein R⁶, R⁷, R⁸, R¹¹ and R¹² are, independently, any organic grouping;
X′ is selected from, C₀₋₂₀alkylene, which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping,
under thermal reaction conditions in the absence of a catalyst.

In a further embodiment, the formation of the triazole leads to a cross-link between two polymers. In this embodiment, R⁹ and/or R¹⁰ in the compounds of Formula (VI) comprise one or more alkynyl groups or R¹² in the compounds of Formula (IX) comprise one or more azide groups. For example, a mono-, di-, oligo- or polyazidosilicone is reacted with a di-, oligo- or polyalkynyl-substituted compound, or a mono-, di-, oligo- or polyalkynylsilicone is reacted with a di-, oligo- or polyazido-substituted compound and said reaction forms crosslinks between the silicone polymers.

In a further embodiment of the present disclosure, the mono-, di-, oligo- or poly-azide and the mono-, di-, oligo- or poly-alkyne moieties are located on the same molecule and the intramolecular and/or intermolecular formation of triazole rings leads to a cross-linked silicone elastomer.

In an application of the method of the disclosure there is included a method for crosslinking two or more polymeric silicon films at a desired time comprising placing two or more polymeric silicon films having one or more azide groups into contact with each other along with a crosslinking agent comprising one or more alkynes, or two or more polymeric silicon films having one or more alkyne groups into contact each other along with a crosslinking agent comprising one or more azide groups, or a polymeric silicon film comprising one or more alkyne groups and a polymeric silicon film containing one or more azide groups, and when crosslinking is desired, heating the films to a temperature to affect the reaction between the one or more azides with the one or more alkynes to form one or more triazoles as the crosslinks between the films. Once cross-linked, the films will be joined or “glued” together. In an embodiment of the disclosure, the polymeric silicon film is a silicone film.

The examples provided herein also show how hybrid hydrophilic polymer-siloxane co-networks, specifically polyethylene oxide-siloxane co-networks, can be easily prepared using the method of the present disclosure. Accordingly, in a further embodiment of the present disclosure, the organosilicon compound is an organosilicon-containing polymer, such as a siloxane or silicone, and the compound comprising at least one alkyne group is a hydrophilic polymer and the compound comprising at least one azide group is a hydrophilic polymer. Therefore in this embodiment of the disclosure, the method involving the reaction of the compounds of formula II with the compounds of formula III and the method involving the reaction of the compounds of formula V with the compounds of formula VI, each of the compounds of formulae II, III, V and VI are polymeric, with the silicon-containing polymer being hydrophobic in character and the other polymer being hydrophilic in character. In this manner, amphiphilic polymer co-networks (APCNs) are prepared.

Examples of hydrophilic-hydrophobic amphiphilic co-networks prepared according to the methods of the present disclosure include reaction products of silicone polymers and anionic (such as polyacrylic acid and its salts such as poly(sodium acrylate)), neutral (such as poly(hydroxyethyl methacrylate)(or pHEMA) or poly (methyl methacrylate (pMMA)) or cationic (such as poly(allylamine)) hydrophilic polymers. These hydrophilic polymers can be easily modified in order to incorporate azido or propiolate esters in their structure (for example, pHEMA is easily esterified by propiolic acid under standard coupling conditions).

Minor modifications in the methods to provide suitable reaction conditions to prepare the desired products include the choice of solvent, and particularly the use of binary solvent systems (such as DMF:chloroform, or dioxane:water), in order to solubilize the two reactants. Very interestingly, the Click reaction between two reactants does not require the use of any solvent-heterogeneous metal-free coupling also yielded the corresponding triazole cross-linked amphiphilic co-networks. In this case, the reactants are vigorously and magnetically stirred at a more elevated temperature (typically from 40 to 90° C.) for a limited time (from a few minutes to several hours, depending on the molecular weight of the precursors), in order to partially crosslink the starting polymeric azide and alkyne derivatives. Then, the mixture is cast in a vial or Petri dish for the final curing process at a suitable temperature (from room temperature to 100° C.).

The methods of the present disclosure can be applied to the synthesis of siloxane-hydrophilic polymer composites wherein the hydrophilic polymer is selected from, for example but not limited to: an alkynyl or azido derivative of an alkynyl or azido derivative of poly(acrylamide), poly(acrylamide-co-acrylic acid) and their total or partial salts, poly(acrylamide-co-diallyldimethylammonium chloride), poly(2-acrylamido-2-methyl-1-propanesulfonic acid), poly(2-acrylamido-2-methyl-1-propanesulfonic acid-co-acrylonitrile), poly(acrylic acid) and its partial or total salts, poly(acrylic acid-co-maleic acid), poly(acrylic acid (partial sodium salt)-graft-poly(ethylene oxide), poly(allylamine), poly(allylamine hydrochloride), 1-[N-[poly(3-allyloxy-2-hydroxypropyl)]-2-aminoethyl]-2-imidazolidinone, poly(aniline) (emeraldine salt), poly(3,3′,4,4′-biphenyltetracarboxylic dianhydride-co-1,4-phenylenediamine), poly[bis(2-chloroethyl)ether-alt-1,3-bis[3-poly[1,4-bis(hydroxyethyl)terephthalate-alt-ethyloxyphosphate], poly[1,4-bis(hydroxyethyl)terephthalate-alt-ethyloxyphosphate]-co-1,4-bis(hydroxyethyl)-co-terephtalate, poly(bis(4-sulfophenoxy)phosphazene), polybutadiene-epoxy, hydroxy functionalized, poly(butyl acrylate), poly(tert-butyl acrylate-co-ethyl acrylate-co-methacrylic acid), poly(1,4-butylene adipate), poly(1,4-butylene succinate), poly(butyl methacrylate), poly(tert-butyl methacrylate), poly(tert-butyl methacrylate-co-glycidyl methacrylate), poly(butyl methacrylate-co-isobutyl methacrylate), poly(butyl methacrylate-co-methyl methacrylate), polycaprolactone, polycaprolactonediol, poly(caprolactone-block-polytetrahydrofuran-block-polycaprolactone), polycaprolactonetriol, poly((o-cresyl glycidylether)-co-formaldehyde), poly(9,9-di-(3′,7′-dimethyloctyl)fluoren-2,7-yleneethynyl-ene), poly(2,5-didodecylphenylene-1,4-ethynylene), poly[di(ethyleneglycol)adipate], polyfluorene and its 9,9-substituted polymers and copolymers, poly(dimethylamine-co-epichlorohydrin-co-ethylenediamine), poly(2-dimethylamino)ethyl methacrylate)methylchloride quaternary salt, polydimethylsiloxane and its co-, graft-, block, polymers and copolymers, poly(dimethylsiloxane)-graft-polyacrylates, poly(epoxysuccinic acid,) polyester-block-polyether diol, poly(vinylphosphonic acid), poly(2-ethylacrylic acid), poly(ethylene glycol), poly(ethylene glycol)-block-poly(caprolactone)methyl ether, poly(ethylene glycol)-block-polylactide methyl ether, poly(ethylene glycol)-block-poly(propylene glycol)-block-poly(ethylene glycol), poly(ethyleneimine), poly(ethylene-alt-maleic anhydride), polyethylene-graft-maleic anhydride, poly(ethylene-co-methacrylic acid) and its total and partial salts, poly(ethylene-co-methyl acrylate-co-glycidyl methacrylate), poly(ethylene oxide), poly(ethylene oxide)-4-arms, poly(ethylene oxide)-harms, and their carboxylic acid, hydroxyl, and thiol-terminated analogs, poly(ethylene oxide)-block-polycaprolactone, 4arms, poly(ethylene oxide)-block-polylactide, 4arms, poly(ethylene succinate), polyethyleneimine, branched, polyethyleneimine-ethoxylated, poly(2-ethyl-2-oxazoline), polyglycolic acid, polyglycolide, poly(3-hydroxybutyric acid), poly(3-hydroxybutyric acid-co-3-hydroxyvaleric acid), poly(2-hydroxyethyl methacrylate), poly(isobutylene-co-maleic acid) and its sodium salts, poly(isobutylene-co-maleic acid, ammonium salt)-co-(isobutylene-alt-maleic anhydride), poly(N-isopropylacrylamide), polylactic acid, polylactide, poly(lactide-co-caprolactone), poly(lactide-co-ethyleneglycol-co-ethyloxyphosphate), poly(lactide-co-glycolide), polylactide-block-poly(ethyleneglycol)-block-polylactide, poly(methylvinylether-alt-maleic anhydride), poly((phenylglycidyl ether)-co-formaldehyde), poly(2-propylacrylic acid), poly(propylene glycol), poly(propylene glycol)-block-poly(ethylene glycol)-block-poly (propylene glycol), polypyrrole, poly(sodium 4-styrenesulfonate), poly(styrene)-block-poly(acrylic acid), poly(4-styrenesulfonicacid) and its salts, poly(4-styrenesulfonic acid-co-maleic acid) and its salts, poly(tetrahydrofuran), poly(thiophene)polyurethane, poly(vinyl alcohol), poly(vinyl chloride), poly(vinyl acetate), poly(vinylphosphonic acid), poly(4-vinylpyridine), polyvinylpyrrolidone, poly(vinylsulfate) and its salts and polyvinylsulfonic acid.

Azido- or activated alkyne-modified (such as propiolic acid-modified) derivatives of the previously cited polymers, and also of their corresponding monomers, as well as their mixtures or their copolymers (block, graft or alt) can be used in the methodology described herein, i.e. for the formation of a siloxane composite-containing triazole rings by the thermal, metal free cycloaddition of alkyne- and azido-functionalized precursors.

The present disclosure also includes a compound prepared using the methods of the disclosure. The compounds prepared using the method of the present disclosure are necessarily free of any metal catalyst, for example, copper.

Accordingly, the present disclosure includes a compound of formula (Ia) and/or (Ib):

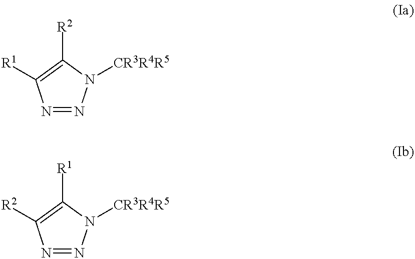

wherein R¹, R², R³, R⁴ and R⁵ are, independently, any organic grouping and at least one of R¹, R², R³, R⁴ and R⁵ comprises at least one silicon atom.

In an embodiment of the disclosure, R¹ and R² are the same or different and are selected from the group H, C₆₋₁₄aryl, C₅₋₁₄heteroaryl, C₁₋₆alkyleneC₆₋₁₄aryl, C₁₋₆alkyleneC₅₋₁₄heteroaryl, C₁₋₂₀alkyl, C(O)C₁₋₂₀alkyl, hydroxy-substituted-C₁₋₂₀alkyl, C₁₋₆alkyleneNHC(O)C₁₋₂₀alkyl, C₁₋₆alkyleneNHC(O)-hydroxy-substituted-C₁₋₂₀alkyl and C₁₋₆alkyleneNHC(O)CHR¹²NR¹³R¹⁴, wherein R¹² is a residue of a natural amino acid and R¹³ and R¹⁴ are independently selected from H, C₁₋₆alkyl and a protecting group.

In a further embodiment of the disclosure, two of R³, R⁴ and R⁵ are H and the other of R³, R⁴ and R⁵ is selected from the group C₁₋₂₀alkyleneSi(C₁₋₆alkyl)₃, C₁₋₂₀alkyleneSi—O—Si(C₁₋₆alkyl)₃, C₁₋₂₀alkyleneSi—O—SiC₁₋₆alkylene-N₃.

Also included in the present disclosure is a silicone polymer comprised of repeating monomer units of the formulae (IVa) and (IVb) and/or (IVc):

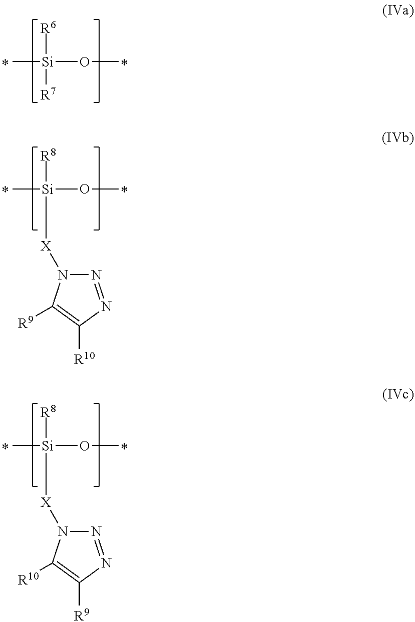

wherein R⁶, R⁷, R⁸, R⁹ and R¹⁵ are, independently, any organic grouping;
X is selected from, C₁₋₂₀alkylene, which is optionally substituted with one or more organic groupings and/or in which one or more carbon atoms is optionally replaced with an arylene, a heteroatom and/or —C(Q)- wherein Q is a heteroatom; and
* represents a linkage to another monomer unit or to a terminal grouping.

In an embodiment of the disclosure, R⁶, R⁷ and R⁸ are the same or different and are independently selected from C₁₋₂₀alkyl, C₆₋₁₄aryl and C₁₋₆alkyleneC₆₋₁₄aryl with the alkyl and aryl groups being optionally further substituted with one or more halo or C₁₋₆alkyl.

In an embodiment of the disclosure, R⁹ and R¹⁹ are the same or different and are selected from the group H, C₆₋₁₄aryl, C₆₋₁₄heteroaryl, C₁₋₆alkyleneC₆₋₁₄aryl, C₁₋₆alkyleneC₆₋₁₄heteroaryl, C₁₋₂₀alkyl, C(O)C₁₋₂₀alkyl, hydroxy-substituted-C₁₋₂₀alkyl, C₁₋₆alkyleneNHC(O)C₁₋₂₀alkyl, C₁₋₆alkyleneNHC(O)-hydroxy-substituted-C₁₋₂₀alkyl, a hydrophilic polymer and C₁₋₆alkyleneNHC(O)CHR¹²NR¹³R¹⁴, wherein R¹² is a natural amino acid residue and R¹³ and R¹⁴ are independently selected from H, C₁₋₆alkyl and a protecting group.

Also included in the present disclosure is a silicone polymer comprised of repeating monomer units of the formulae (VIIa) and (VIIb) and/or (VIIc):

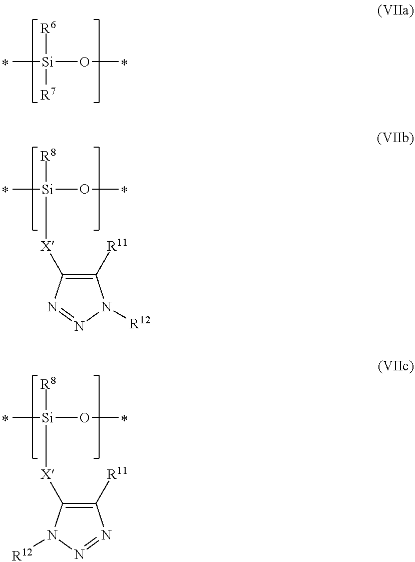

wherein R⁶, R⁷, R⁸, R¹¹ and R¹² are, independently, any organic grouping;
X′ is selected from, C₀₋₂₀alkylene which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping.

In an embodiment of the disclosure, R⁶, R⁷ and R⁸ are the same or different and are independently selected from C₁₋₂₀alkyl, C₆₋₁₄aryl and C₁₋₆alkyleneC₆₋₁₄aryl with the alkyl and aryl groups being optionally further substituted with one or more halo or C₁₋₆alkyl.

In an embodiment of the disclosure, R¹¹ is selected from the group H, C₆₋₁₄aryl, C₅₋₁₄heteroaryl, C₁₋₆alkyleneC₆₋₁₄aryl, C₁₋₆alkyleneC₆₋₁₄heteroaryl, C₁₋₂₀alkyl, C(O)C₁₋₂₀alkyl, hydroxy-substituted-C₁₋₂₀alkyl, C₁₋₆alkyleneNHC(O)C₁₋₂₀alkyl, C₁₋₆alkyleneNHC(O)-hydroxy-substituted-C₁₋₂₀alkyl and C₁₋₆alkyleneNHC(O)CHR¹²NR¹³R¹⁴, wherein R¹² is a natural amino acid residue and R¹³ and R¹⁴ are independently selected from H, C₁₋₆alkyl and a protecting group.

In an embodiment of the disclosure, R¹² is selected from the group H, C₆₋₁₄aryl, C₅₋₁₄heteroaryl, C₁₋₆alkyleneC₆₋₁₄aryl, C₁₋₆alkyleneC₆₋₁₄heteroaryl, C₁₋₂₀alkyl, C(O)C₁₋₂₀alkyl, hydroxy-substituted-C₁₋₂₀alkyl, C₁₋₆alkyleneNHC(O)C₁₋₂₀alkyl, C₁₋₆alkyleneNHC(O)-hydroxy-substituted-C₁₋₂₀alkyl, a hydrophilic polymer and C₁₋₆alkyleneNHC(O)CHR¹²NR¹³R¹⁴, wherein R¹² is a natural amino acid residue and R¹³ and R¹⁴ are independently selected from H, C₁₋₆alkyl and a protecting group.

In an embodiment of the disclosure, the hydrophilic polymer in R⁹, R¹⁰ or R¹² is selected from the poly(acrylamide), poly(acrylamide-co-acrylic acid) and their total or partial salts, poly(acrylamide-co-diallyldimethylammonium chloride), poly(2-acrylamido-2-methyl-1-propanesulfonic acid), poly(2-acrylamido-2-methyl-1-propanesulfonic acid-co-acrylonitrile), poly(acrylic acid) and its partial or total salts, poly(acrylic acid-co-maleic acid), poly(acrylic acid (partial sodium salt)-graft-poly(ethylene oxide), poly(allylamine), poly(allylamine hydrochloride), 1-[N-[poly(3-allyloxy-2-hydroxypropyl)]-2-aminoethyl]-2-imidazolidinone, poly(aniline) (emeraldine salt), poly(3,3′,4,4′-biphenyltetracarboxylic dianhydride-co-1,4-phenylenediamine), poly[bis(2-chloroethyl)ether-alt-1,3-bis[3-poly[1,4-bis(hydroxyethyl)terephthalate-alt-ethyloxyphosphate], poly[1,4-bis(hydroxyethyl)terephthalate-alt-ethyloxyphosphate]-co-1,4-bis(hydroxyethyl)-co-terephtalate, poly(bis(4-sulfophenoxy)phosphazene), polybutadiene-epoxy, hydroxy functionalized, poly(butyl acrylate), poly(tert-butyl acrylate-co-ethyl acrylate-co-methacrylic acid), poly(1,4-butylene adipate), poly(1,4-butylene succinate), poly(butyl methacrylate), poly(tert-butyl methacrylate), poly(tert-butyl methacrylate-co-glycidyl methacrylate), poly(butyl methacrylate-co-isobutyl methacrylate), poly(butyl methacrylate-co-methyl methacrylate), polycaprolactone, polycaprolactonediol, poly(caprolactone-block-polytetrahydrofuran-block-polycaprolactone), polycaprolactonetriol, poly((o-cresyl glycidylether)-co-formaldehyde), poly(9,9-di-(3′,7′-dimethyloctyl)fluoren-2,7-yleneethynyl-ene), poly(2,5-didodecylphenylene-1,4-ethynylene), poly[di(ethyleneglycol)adipate], polyfluorene and its 9,9-substituted polymers and copolymers, poly(dimethylamine-co-epichlorohydrin-co-ethylenediamine), poly(2-dimethylamino)ethyl methacrylate)methylchloride quaternary salt, polydimethylsiloxane and its co-, graft-, block, polymers and copolymers, poly(dimethylsiloxane)-graft-polyacrylates, poly(epoxysuccinic acid,) polyester-block-polyether diol, poly(vinylphosphonic acid), poly(2-ethylacrylic acid), poly(ethylene glycol), poly(ethylene glycol)-block-poly(caprolactone)methyl ether, poly(ethylene glycol)-block-polylactide methyl ether, poly(ethylene glycol)-block-poly(propylene glycol)-block-poly(ethylene glycol), poly(ethyleneimine), poly(ethylene-alt-maleic anhydride), polyethylene-graft-maleic anhydride, poly(ethylene-co-methacrylic acid) and its total and partial salts, poly(ethylene-co-methyl acrylate-co-glycidyl methacrylate), poly(ethylene oxide), poly(ethylene oxide)-4-arms, poly(ethylene oxide)-harms, and their carboxylic acid, hydroxyl, and thiol-terminated analogs, poly(ethylene oxide)-block-polycaprolactone, 4arms, poly(ethylene oxide)-block-polylactide, 4arms, poly(ethylene succinate), polyethyleneimine, branched, polyethyleneimine-ethoxylated, poly(2-ethyl-2-oxazoline), polyglycolic acid, polyglycolide, poly(3-hydroxybutyric acid), poly(3-hydroxybutyric acid-co-3-hydroxyvaleric acid), poly(2-hydroxyethyl methacrylate), poly(isobutylene-co-maleic acid) and its sodium salts, poly(isobutylene-co-maleic acid, ammonium salt)-co-(isobutylene-alt-maleic anhydride), poly(N-isopropylacrylamide), polylactic acid, polylactide, poly(lactide-co-caprolactone), poly(lactide-co-ethyleneglycol-co-ethyloxyphosphate), poly(lactide-co-glycolide), polylactide-block-poly(ethyleneglycol)-block-polylactide, poly(methylvinylether-alt-maleic anhydride), poly((phenylglycidyl ether)-co-formaldehyde), poly(2-propylacrylic acid), poly(propylene glycol), poly(propylene glycol)-block-poly(ethylene glycol)-block-poly (propylene glycol), polypyrrole, poly(sodium 4-styrenesulfonate), poly(styrene)-block-poly(acrylic acid), poly(4-styrenesulfonicacid) and its salts, poly(4-styrenesulfonic acid-co-maleic acid) and its salts, poly(tetrahydrofuran), poly(thiophene)polyurethane, poly(vinyl alcohol), poly(vinyl chloride), poly(vinyl acetate), poly(vinylphosphonic acid), poly(4-vinylpyridine), polyvinylpyrrolidone, poly(vinylsulfate) and its salts and polyvinylsulfonic acid. In another embodiment of the disclosure, the hydrophilic polymer is PEO.

The following non-limiting examples are illustrative of the present disclosure:

### (III) Examples

### Materials and Methods

1,3-Bis(chloropropyl)tetramethyldisiloxane and (chloropropyl)-methylsiloxane-dimethyl-siloxane copolymer (14-16 mole % (chloropropyl)methylsiloxane) were obtained from Gelest/ABCR and Gelest respectively. Sodium azide (95%) was purchased from J. T. Baker. Sodium iodide (99%), adipoyl chloride (97%), pyridine (99%), propargyl alcohol (99%), 3-butyn-2-methyl-2-ol (98%), phenylacetylene (98%), propargyl amine (98%), Boc-L-alanine (98%), Cbz-L-valine (99%) and dimethylacetylene dicarboxylate (99%), gluconolactone (99%) were obtained from Sigma-Aldrich. Triethylamine (99%) was purchased from EMD. Sodium ascorbate (98%) and EDC (98%) were obtained from Fluka, while copper(II) sulfate pentahydrate (99%) was purchased from Fisher Scientific. Propiolic acid (95%), poly(ethylene oxide) (mono-methoxy terminated, MWs of 350, 750 OR 2000, or dihydroxy-terminated, MW of 600, 1000 or 2000) were obtained from Sigma-Aldrich. Concentrated sulfuric acid (96%) and solvents (reagent grade) were purchased from Caledon. All materials were used as received.

IR analysis was made using a Bio-Rad Infrared Spectrometer (FTS-40). ¹H NMR and ¹³C NMR was recorded at room temperature on a Bruker AC-200 spectrometer using CDCl₃ or DMSO as solvent. High-resolution mass spectrometry was performed with a Hi-Res Waters/Micromass Quattro Global Ultima (Q-TOF mass spectrometer). TGA analysis was performed using NETZCH STA 409 PC/PG.

Precursors for Click-reaction of silicones include azide- or alkyne-terminated siloxanes. Chloropropyl-terminated siloxanes are available in a wide range of molecular weights, and a classical nucleophilic substitution by the azide anion yielded the corresponding azidopropyl derivative.

### Example 1

In one example, 1,3-bis(chloropropyl)tetramethyldisiloxane (BCPTMDS) was chosen as the starting material. When treated with an excess of sodium azide in DMF, this approach proved successful and gave 1,3-bis(azidopropyl)tetramethyldisiloxane (BAPTMDS) in a 96% isolated yield (see Scheme 2).

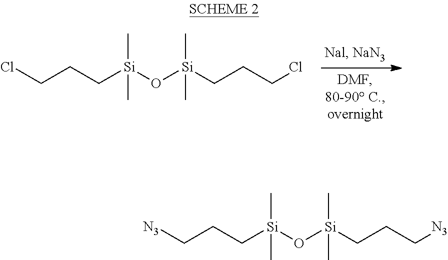

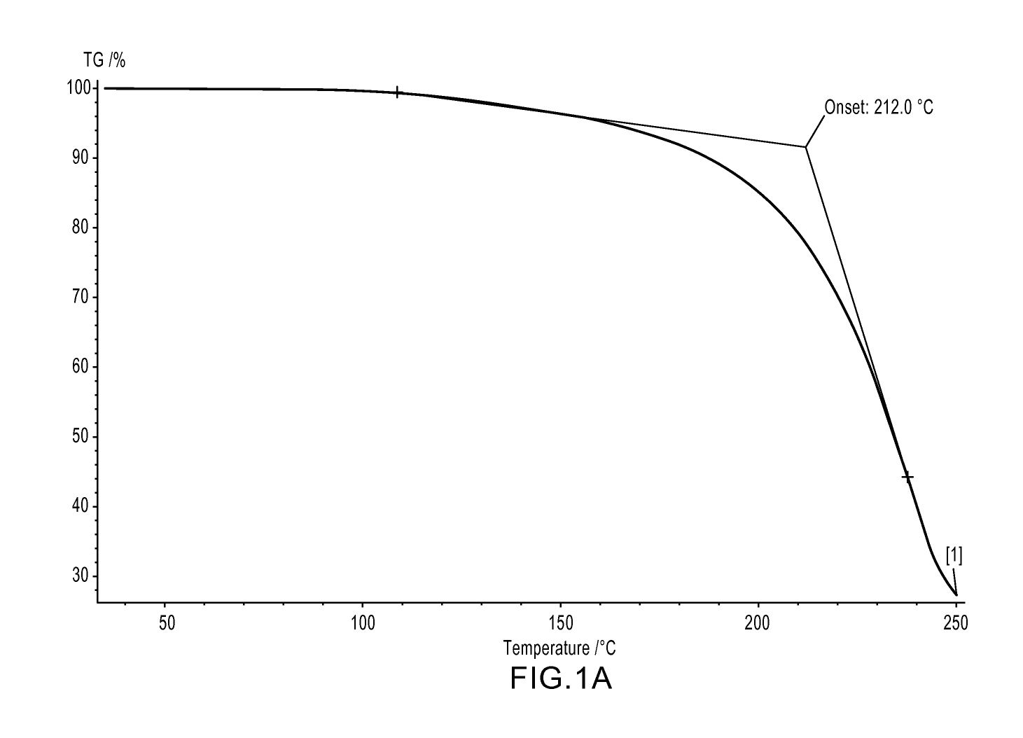

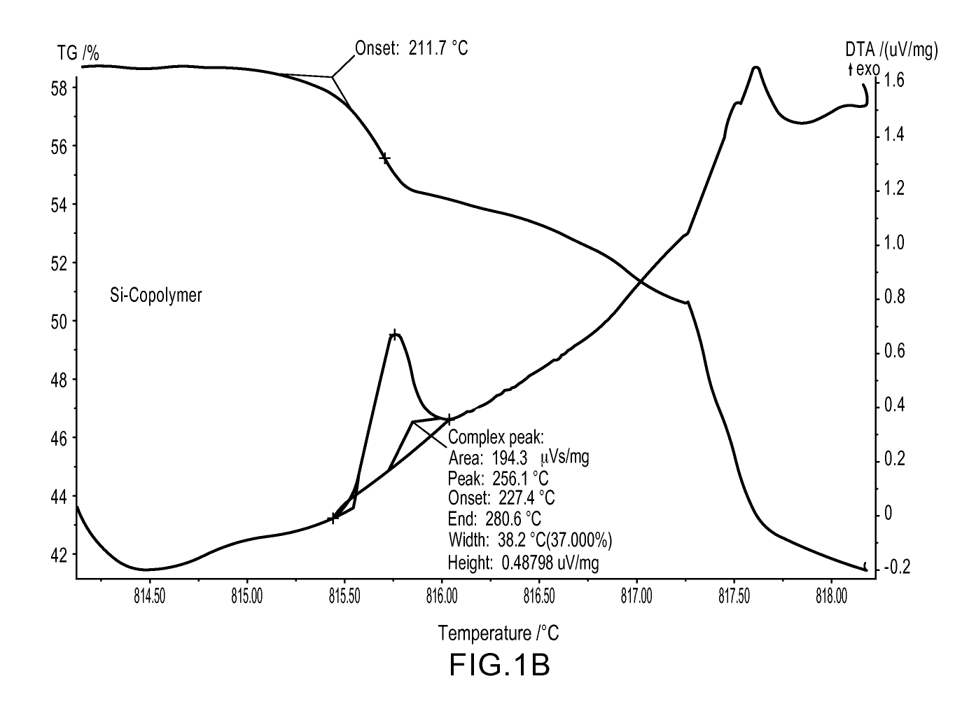

The reaction was followed by proton NMR, which shows the total disappearance of the triplet at 3.52 ppm (protons in a to chlorine) and their replacement by a triplet at 3.22 ppm (protons a to the azido moiety). It should be noted here that while most azides can be handled without any incident, some members of this class are explosives.³² To establish the thermal stability of the model compound, Thermogravimetric Analysis (TGA) was performed (see FIGS. 1A and 1B). TGA analysis did not reveal any sudden decomposition characteristic of an explosive behavior. Instead, a regular weight loss starting from about 105° C. was observed, despite the presence of 2 azido moieties in the model compound BAPTMDS. This slow decomposition occurs starting at temperatures well above those required to perform thermal Click cycloadditions (from below room temperature to ca. 90° C., depending on the alkyne reactivity).

BATPMDS was obtained by dissolving sodium azide (6.2 g, 96 mmol, 3 equiv.), sodium iodide (9.3 g, 62 mmol, 2 equiv.), and 1,3-bis(chloropropyl)tetramethyldisiloxane (9.0 g, 31 mmol, 1 equiv.) in DMF (40 mL). The mixture was stirred until all reagents dissolved and then heated at 90° C. overnight. The reaction was stopped after ¹H NMR showed the absence of the 1,3-bis(chloropropyl)tetramethyldisiloxane starting material. The reaction mixture was then partitioned between water and dichloromethane. The organic phase was separated, dried over sodium sulfate, then evaporated to give 9.7 g (96%) of the title compound as a light yellow liquid. ¹H NMR (CDCl₃): δ=3.22 (t, J=7.0 Hz, 4H), 1.59 (m, 4H), 0.539 (m, 4H), 0.056 (s, 12H); ¹³C NMR (CDCl₃): δ=54.1, 22.9, 15.2, 0.3; IR (KBr, cm⁻¹): 2097 (N₃); HRMS (ESI): m/z calculated: [M+Ag]⁺=407.0601, found: [M+Ag]⁺=407.0620

### Example 2

Polymeric azidoalkylsilicones can also be formed from chloroalkylsilicones.³⁹ Commercially available dimethylsilicone-co-methylchloropropylsilicones were converted, in an analogous manner to that described above, to the polyazide in DMF. The reaction worked very well particularly given the normal challenges of dissolving hydrophilic salts in hydrophobic media such as silicones (see Scheme 3). The product was isolated in a yield of nearly 100%: no residual chloropropyl groups could be observed by ¹H NMR. TGA analysis (FIG. 1B) showed that the polyazido compound was even more thermally stable than the BAPTMDS (FIG. 1A), with onset of decomposition at about 125° C. Thus, as confirmed below, these materials will undergo cycloaddition reactions at temperatures well below their decomposition temperatures.

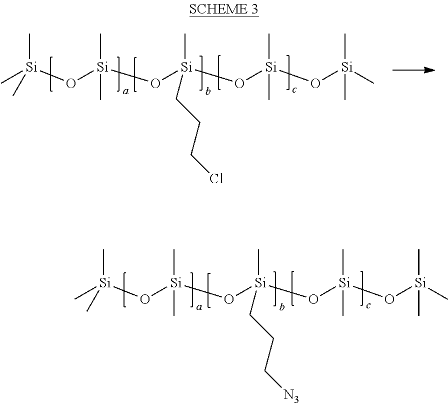

The polymer of Scheme 3 was obtained by dissolving chloropropyl)methylsiloxane-dimethylsiloxane copolymer (14-16 mole % (chloropropyl)methylsiloxane, 10.0 g) in 40 ml of a mixture of DMF and THF (1:1; v:v). Sodium azide (1.0 grams, 15 mmol) was then added, and the mixture was heated at 70° C. for 24 h. At this stage, the reaction was found to be incomplete by proton NMR. Therefore, additional sodium azide (1.0 gram, 15 mmol) was added, and the mixture was heated at 70° C. until completion (48 additional hours, as indicated by proton NMR). The reaction medium was then cooled, added to 300 mL of water, and extracted twice with 100 mL of a mixture of hexanes and ethyl acetate (1:1; v:v). The combined organic phase was dried over Na₂SO₄. Volatiles were removed in vacuo to yield 9.9 grams (99%) of the title compound. ¹H NMR (CDCl₃): δ=4.64 (d, J=2.4 Hz, 18H), 2.44 (m, 2H), 2.32 (m, 2H), 1.66 (m, 2H); ¹³C NMR (CDCl₃): δ=54.2, 22.9, 14.6, 1.2; IR (KBr, cm⁻¹): N₃ stretch=2097 cm⁻¹(s); MS (MALDI-TOF): 6000 (6188-6378), 10000 (10280-10642), 12000 (12318-12872)

### Example 3

The thermal Huisgen cycloaddition reaction of BAPTMDS was carried out at 90° C. with two common, unactivated alkynes, propargyl alcohol and phenylacetylene, respectively. The alkyne was used as both reagent and solvent for the reaction. Both reactions occurred efficiently: Click ligation with propargyl alcohol was complete within only 3 hours, while phenylacetylene required a longer reaction time (ca. 16 to 20 hours). In the two cases, simple removal of the excess alkyne under reduced pressure yielded the Click adduct in quantitative yield (Table 1).

The reaction was repeated with both alkynes at room temperature and no reaction was evident after 1 day of reaction. Thus, thermally-catalyzed Click ligation was found to be slow/undetectable at low temperature, but efficacious at higher temperatures. Such a reaction profile is ideal for the processing of a silicone elastomer, which could be sold as a two part or one part mixed system that will not cure until exposed to elevated temperatures.

The general procedure for the thermal reaction of BAPTMDS with alkynes is illustrated by the thermal reaction between BAPTMDS with propargyl alcohol (Table 1, entry 1): In a 5 mL round-bottomed flask, 1,3-bis(azidopropyl)-tetramethyldisiloxane (300 mg, 1.00 mmol) and propargyl alcohol (1.0 mL, 17.18 mmol) were stirred at 90° C. under a nitrogen atmosphere. Proton NMR indicated that the reaction was complete within 3 h. The resulting mixture was then subjected to vacuum to remove the excess volatile alkyne to yield 412 mg of the product (100% yield). This product was composed of 3 regioisomers (bis-1,4 Click addition; bis-1,5 Click addition; mixed 1,4- and 1,5-Click additions). No attempts were made to separate these regioisomers: ¹H NMR (CDCl₃): δ=7.57 (s, 1.1H), 7.50 and 7.48 (2 singlets, 0.9H). The first signal at 7.57 ppm is attributed to the regioisomer having the 2 hydroxymethyl in position 4 of the triazolyl ring (55% of the addition), while the 2 other singlets correspond to the bis(5-hydroxymethyl) or mixed (4- and 5-hydroxymethyl) regioisomers (45%). 4.75 (br s, 4H), 4.43 (br s, 2H), 4.28 (m, 4H), 1.92 (m, 4H), 0.47 (m, 4H), 0.03 (br s, 12H); ¹³C NMR (CDCl₃): δ=147.9, 136.4, 132.7, 122.1, 122.0, 56.2, 53.1, 52.9, 51.1, 24.8, 24.7, 24.4, 15.2, 15.1-0.3; HRMS (ESI): [M+H]⁺ calculated=413.2153, [M+H]⁺ found: 413.2147. NMR spectra of the pure 1,3-bis((4-hydroxymethyl-1,2,3-triazol-1-yl)propyl)tetramethyldisiloxane, prepared using the copper(I)-catalyzed procedure, are reported below.

### Example 4

For purposes of comparison, the copper(I)-catalyzed reaction was examined. It was observed that generally, copper catalyzed reactions occurred more quickly than the thermal reactions but the thermal reactions obtained superior yields. The copper catalyzed reaction between BAPTMDS and propargyl alcohol or phenylacetylene took only 1 hour to go to completion at room temperature. A variety of other functional groups were investigated as shown in Table 2. All reactions were carried using 2% molar copper(II) catalyst, and 10% molar sodium ascorbate, in solvent systems such as THF:water (1:1; v:v) or DMF:water (5:1; v:v). This catalyst system was simpler (and also cheaper) than use of a copper(I) source, and allows one to avoid the unwanted oxidative coupling usually observed with Cu(I) catalysts^{11, 12} (Table 2). All of the alkynes tested were successfully incorporated into 1,3-BAPTMDS to form the bis-triazole product. The latter show characteristic peaks between 120 and 150 ppm in ¹³C NMR, attributed to the two carbons in the triazole ring. Moreover, in cases where terminal alkynes were used, the proton in the triazole ring was also visible in ¹H NMR (7-8 ppm). The copper catalyzed reaction was found to be regioselective: only one regioisomer was formed from this reaction with terminal alkynes as indicated by the presence of a singlet for the proton in the triazole ring.

One interesting outcome of these experiments was the ‘Click’ reaction involving an internal alkyne, dimethylacetylene dicarboxylate (DMAD), (Table 2, entry 4). It has been reported in the literature^{16, 17, 26, 33} that the copper(I) catalyzed (copper(II) sulfate and sodium ascorbate catalyst system) Huisgen cycloaddition reaction is not practical with internal alkynes such as DMAD because only terminal alkynes can form the copper-acetylide complex, a complex that is generally accepted to be a crucial component in the step-wise mechanism of the copper(I) catalyzed Click reaction, which may also be responsible for the regiospecificity of this process.^{4-7,34} To establish if DMAD is an exception to this rule, or whether the thermally mediated azide-DMAD cycloaddition reactions with this molecule can occur at very low temperatures (thermal Click reactions are usually performed at elevated temperatures, i.e., 70° C. or above),^{11, 12, 34} the thermal 1,3-BAPTMDS-DMAD cycloaddition reaction was attempted at room temperature in the absence of copper catalyst. The non-catalyzed (metal free) reaction was completed in the same time frame as the copper-mediated reaction. This observation opens up potentially interesting opportunities, showing that it is possible to perform thermal Click reactions of mono- or disubstituted electron-deficient (activated) alkynes at ambient temperature.

As a further demonstration of this effect, the reaction of phenylacetylene and propargyl alcohol, respectively, with the diazidosilicone BAPTMDS were compared. The thermal reaction of phenylacetylene occurred more slowly than that of propargyl alcohol, as noted above. By contrast, in water with copper catalysis, phenylacetylene reacted faster than propargyl alcohol. While not wishing to be bound the theory, the origins of this observation may lie in the relative hydrophobicities of both BAPTMDS and the alkyne: phenylacetylene is miscible with BAPTMDS whereas propargyl alcohol, soluble in water, is much less so. The compatibility of 1,3-BAPTMDS and phenylacetylene towards each other and their mutual hydrophobicity (relative insolubility in water) may drive them to be as close as possible together (an enforced hydrophobic interaction³⁶) in the reaction environment, thereby increasing the chance of contact and subsequent coupling. Previous research has noted that such interactions occur in both the Huisgen cycloaddition and Diels-Alder reactions when run in aqueous environments.^{11, 12, 36, 37} This proposal is also supported by the slow reaction of 1,3-BAPTMDS with propargyl alcohol due to problems of miscibility: no reaction had taken place in the copper(I) catalyzed reaction of propargyl alcohol and BAPTMDS after 2 hours.

Alkynylgluconamide³⁸ (Table 2, Entry 5), N-(tert-Butoxycarbonyl)-L-alanine-N′-propargylamide³⁹ (Table 2, Entry 7) were prepared following literature procedures and N-Cbz-L-valine-N′-propargylamide (Table 2, Entry 6) was characterized as follows: ¹H NMR (CDCl₃): δ=8.40 (t, J=5.0 Hz, 1H), 7.35 (s, 5H), 4.95 (s, 2H), 3.85 (m, 2H), 3.10 (s, 1H), 1.91 (m, 1H), 0.82 (d, J=6.6 Hz, 6H); ¹³C NMR (CDCl₃): δ=171.1, 156.1, 137.1, 128.3, 127.7, 81.0, 72.9, 65.4, 60.1, 30.3, 27.8, 19.1, 18.3; IR (KBr, cm⁻¹)=3314 (EC-H (stretch), 3275 (NH), 1685 (C═ONH), 1650 (Ar stretching); HRMS (ESI): m/z [M+H]⁺ calculated=289.1552. [M+H]⁺ found: 289.1552.

The characterization of 1,3-bis((4-phenyl-1,2,3-triazol-1-yl)propyl)tetramethyldisiloxane (Table 1, entry 2; Table 2, entry 3) and 1,3-Bis((5-phenyl-1,2,3-triazol-1-yl)propyl)tetramethyldisiloxane (Table 2, entry 2) is provided below:

Thermal version: ¹H NMR (CDCl₃): δ=7.81 (m, 6H), 7.37 (m, 6H), 4.32 (m, 4H), 1.90 (m, 4H), 0.44 (m, 4H), 0.04 (m, 12); ¹³C NMR (CDCl₃): δ=147.7, 137.8, 133.12, 130.8, 129.5, 129.2, 128.9, 128.1, 127.4, 125.7, 119.7, 68.0, 53.2, 51.1, 24.8, 24.4, 15.1, 0.3; HRMS (ESI): m/z [M+H]⁺ calculated=505.2567, [M+H]⁺ found: 505.2559.

Copper-catalyzed version: ¹H NMR (CDCl₃): δ=7.82 (m, 6H), 7.37 (m, 6H), 4.36 (t, J=7.2 Hz, 4H), 1.94 (m, 4H), 0.52 (m, 4H), 0.06 (s, 12); ¹³C NMR (CDCl₃): δ=147.6, 130.8, 128.9, 128.1, 125.7, 119.8, 53.1, 24.8, 15.2, 0.3; HRMS (ESI): m/z [M+H]⁺ calculated=505.2567, [M+H]⁺; found: 505.2584.

The general procedure for the copper-catalyzed reaction of BAPTMDS with alkynes is illustrated by the thermal reaction between BAPTMDS with propargyl alcohol (Table 2, entry 1): 1,3-bis(azidopropyl)tetramethyldisiloxane (300 mg, 1.0 mmol) and propargyl alcohol (168 mg, 3.0 mmol, 1.5 equiv. for each azide) were solubilized in 2 mL of THF. Sodium ascorbate (49 mg, 0.25 mmol, in 1.00 mL of water) was added, followed by copper(II) sulfate pentahydrate (13 mg, 0.05 mmol, in 1.00 mL of water). The mixture was stirred vigorously for two days, at which stage ¹H NMR indicated the complete consumption of the starting materials. The reaction mixture was fractionated between water and dichloromethane. The aqueous phase was extracted three times with dichloromethane. The combined organic phase was dried over sodium sulfate, filtered, evaporated then passed through a short pad of neutral alumina to afford 94% of the Click adduct. For alkynyl amino acids, DMF was used in lieu of THF. See thermal section, above for spectra.

The following compounds have been prepared in accordance to the general procedure and characterized as follows:

### (a) 1,3-Bis((4-(1,1-dimethyl)hydroxymethyl-1,2,3-triazol-1 yl)propyl)tetramethyldisiloxane (Table 2, entry 2)

1,3-Bis(azidopropyl)tetramethyldisiloxane (300 mg, 1.0 mmol); 3-Butyn-2-methyl-2-ol (252 mg, 3.0 mmol, 1.5 equiv. for each azide); Yield: 95% (468 mg). ¹H NMR (CDCl₃): δ=7.50 (s, 2H), 4.26 (t, J=7.4 Hz, 4H), 3.49 (s, 2H), 1.89 (m, 4H), 1.64 (s, 12), 0.509 (m, 4H), 0.04 (s, 12); ¹³C NMR (CDCl₃): δ=155.8, 119.4, 68.5, 53.0, 30.5, 24.7, 15.2, 0.3; MS (ESI): m/z [M+H]⁺ calculated=469.2779, [M+H]⁺; found: 469.2770, [M+Na]⁺ found: 492.2617.

### (b) 1,3-Bis((4-phenyl-1,2,3-triazol-1-yl)propyl)tetramethyldisiloxane (Table 2, entry 3)

1,3-Bis(azidopropyl)tetramethyldisiloxane (300 mg, 1.0 mmol) and phenylacetylene (306 mg, 3.0 mmol, 1.5 equiv. for each azide) were reacted using the same conditions as above to give 484 mg (96%) of the product. See thermal section, above for spectra

### (c) 1,3-Bis((4,5-dimethylcarboxy-1,2,3-triazol-1-yl)propyl)tetramethyldisiloxane (Table 2, entry 4)

1,3-Bis(azidopropyl)tetramethyldisiloxane (300 mg, 1.0 mmol); dimethylacetylene-dicarboxylate (426 mg, 3.0 mmol, 1.5 equiv. for each azide); yield: 92% (554 mg). ¹H NMR (CDCl₃): δ=4.56 (t, J=7.2 Hz, 4H), 3.99 (s, 6H), 3.97 (s, 6H), 1.90 (m, 4H), 0.48 (m, 4H), 0.03 (s, 12); ¹³C NMR (CDCl₃): δ=160.6, 159.1, 139.9, 129.9, 53.5, 53.2, 24.6, 15.0, 0.2; MS (ESI): m/z [M+H]⁺ calculated=585.2161, [M]⁺ found: 585.2158, [M+NH₄]⁺ found: 602.2595.

### (d) 1,3-Bis((4-N-methylenegluconamide-1,2,3-triazol-1-yl)propyl)tetramethyldisiloxane (Table, entry 5)

1,3-Bis(azidopropyl)tetramethyldisiloxane (300 mg, 1.0 mmol); gluconoamide (700 mg, 3.0 mmol, 1.5 equiv. for each azide); yield: 94% (721 mg). ¹H NMR (CDCl₃): δ=8.10 (t, J=5.6 Hz, 2H), 7.86 (s, 2H), 5.46 (d, J=4.0 Hz, 2H), 4.26 (m, 24H), 1.77 (m, 4H), 0.43 (m, 4H), 0.025 (s, 12); ¹³C NMR (CDCl₃): δ=173.1, 145.4, 123.2, 74.1, 72.7, 71.9, 70.6, 63.7, 52.4, 34.6, 24.6, 14.9, 0.7; MS (ESI): m/z [M+H]⁺ calculated=767.3427, [M+H]⁺ found: 767.3398.

### (e) 1,3-Bis((4-N-methylene-Cbz-valineamide-1,2,3-triazol-1-yl)propyl)tetramethyldisiloxane (Table 2, entry 6)

1,3-Bis(azidopropyl)tetramethyldisiloxane (300 mg, 1.0 mmol);d N-Cbz-L-valine-N′-propargylamide (867 mg, 3.0 mmol, 1.5 equiv. for each azide); in lieu of THF, DMF was the co-solvent used; yield: 100% (877 mg). ¹H NMR (CDCl₃): δ=8.43 (t, J=5.6 Hz, 2H), 7.85 (s, 2H), 7.27 (m, 12H), 5.09 (s, 4H), 4.30 (m, 8H), 3.82 (t, J=7.4 Hz, 2H), 1.87 (m, 2H), 1.74 (m, 4H), 0.78 (d, J=6.6 Hz, 12H), 0.39 (m, 4H), 0.004 (s, 12); ¹³C NMR (CDCl₃): δ=171.7, 156.7, 145.1, 137.6, 128.8, 128.1, 123.3, 65.9, 60.7, 52.4, 34.7, 30.8, 24.7, 19.7, 18.8, 14.9, 0.7; MS (ESI): m/z [M+]⁺ calculated=877.4576, [M]⁺ found: 877.4539.

### (f) 1,3-Bis((4-N-methylene-Boc-alanineamide-1,2,3-triazol-1-yl)propyl)tetramethyldisiloxane (Table 2, entry 7)

1,3-Bis(azidopropyl)tetramethyldisiloxane (300 mg, 1.0 mmol); N-(tert-butoxycarbonyl)-L-alanine-N′-propargylamide (732 mg, 3.0 mmol, 1.5 equiv. for each azide); in lieu of THF, DMF was utilized as the co-solvent; yield: 95% (715 mg).¹H NMR (CDCl₃): δ=8.26 (t, J=4.8 Hz, 2H), 7.82 (s, 2H), 6.90 (d, J=7.0 Hz, 2H), 4.26 (m, 8H), 3.96 (m, 2H), 1.71 (m, 4H), 1.24 (s, 24H), 1.12 (d, J=7.6 Hz, 6H), 0.41 (m, 4H), 0.005 (s, 12H); ¹³C NMR (CDCl₃): δ=172.9, 169.7, 145.0, 122.6, 78.0, 52.0, 49.8, 34.4, 28.0, 24.2, 18.1, 14.5, 0.2; MS (ESI): m/z [M+H]⁺ calculated=753.4263, [M+H]⁺ found: 753.4241.

### Example 5

The polyazide was amenable to Click chemistry in analogy with the model disiloxane compound of Example 3. Two reactions demonstrated the efficacy of this functionalization reaction. In the first reaction, an excess of phenylacetylene was reacted with the polysiloxane-azide in the absence of solvent, at 90° C. The reaction was complete within one day and gave a pale yellow-orange, higher viscosity oil. Simple removal of the excess phenylacetylene under reduced pressure afforded the corresponding coupling product in quantitative yield, demonstrating the ease and efficiency of the thermal approach. NMR studies indicated complete conversion of azido groups to triazole rings (easily monitored by the olefinic protons in the a position).

For comparison, an example of a copper-catalyzed Click reaction was also performed with the polyazide, using a highly polar alkyne: ethynyl gluconamide (entry 2 of Table 3). Reaction for 2 days, under standard copper-catalyzed conditions (in a binary solvent water:THF, 1:1, vol:vol), afforded the polymeric glucose-siloxane composite product in 84% yield. A simple filtration was performed to isolate a pure product: after reaction, the reaction medium was slowly added to 100 mL of water under stirring. The functionalized-polymeric product precipitated, while copper and ascorbate salts remained in solution.

The functionalized polymer of Table 3, entry 1 was prepared by stirring, in a 5 mL round-bottomed flask, poly(azidopropyl)-co-poly(dimethyl)siloxane (0.706 g; 1.2 mmol of repeating unit) and phenylacetylene (1.0 g; 9.8 mmol) at 90° C. under a nitrogen atmosphere for 24 h. Volatiles were then removed in vacuo to yield 0.860 g (quantitative yield) of poly(phenyl-triazolyl) derivatives as a viscous yellow-orange oil. ¹H NMR (CDCl₃): δ=7.55 (s, 1H), 7.51 (s, 1H), 4.71 (m, 4H), 4.24 (m, 4H), 3.69 (m, 2H), 1.82 (m, 4H), 0.43 (m, 4H), 0.01 (m, 12H); ¹³C NMR (CDCl₃): δ=147.9, 136.6, 132.6, 122.1, 67.9, 55.9, 53.0, 52.6, 51.0, 25.5, 24.6, 24.3, 15.0, 0.2; MS (ESI): [M+H]⁺ calculated=413.2153, [M+H]⁺ found: 413.2147.

The functionalized polymer of Table 3, entry 2 was prepared by dissolving, in a 5 mL round-bottomed flask, poly(azidopropyl)-co-poly(dimethyl)siloxane (0.723 g, 1.2 mmol of repeating unit) in 1 mL of THF. Ethynylgluconamide (500 mg, 2.1 mmol) dissolved in 3 mL water was added. Sodium ascorbate (49 mg, 0.25 mmol) was then added, followed by copper(II) sulfate pentahydrate (13 mg, 0.05 mmoles). The mixture was stirred vigorously for two days. It was then slowly added to 100 mL of water, which resulted in precipitation of a fluffy solid. The solid was filtered, dissolved again in a minimum amount of water/THF (1:1, vol:vol), and precipitated again in 100 mL of water. The solid was filtrated, and dried in vacuo to yield 0.848 g (84%) of the Click-adduct. ¹H NMR (DMSO-d₆): δ=7.55 (s, 1H), 7.51 (s, 1H), 4.71 (m, 4H), 4.24 (m, 4H), 3.69 (m, 2H), 1.82 (m, 4H), 0.43 (m, 4H), 0.01 (m, 12H); ¹³C NMR (CDCl₃): δ=147.9, 136.6, 132.6, 122.1, 67.9, 55.9, 53.0, 52.6, 51.0, 25.5, 24.6, 24.3, 15.0, 0.2; MS (ESI): [M+H]⁺ calculated=413.2153, [M+H]⁺ found: 413.2147.

### Example 6

The polyazidosilicone may also be crosslinked using Click chemistry. Silicones bearing more than one alkyne can be prepared by traditional means, including the Grignard reaction of XMgCH₂C≡CH (X═Cl, Br) with chlorosilanes (e.g., Me₂SiCl₂+BrMgCH₂C≡CH→Me₂SiClCH₂C≡CH→HC≡CCH₂Me₂SiOSiMe₂CH₂C≡CH). Alternatively, alkynes may be introduced through use of functional spacers. For example, the bis-terminated propynoic ester of 1,4-bis(hydroxybutyl)tetramethyl disiloxane was used as a model compound to verify the viability of this approach. This compound was easily prepared using conventional EDC coupling, as shown in Scheme 4. Other polyalkynes are also readily prepared, including the dipropargyl ester of adipic acid, or are available commercially, such as tri(propargyl)amine or 1,4-diethynyl-benzene (Scheme 5).

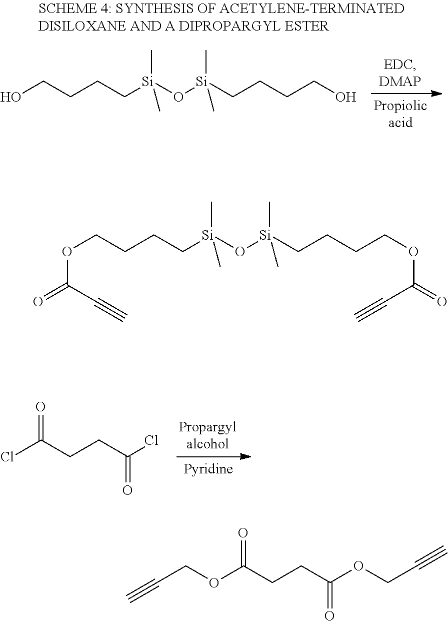

Dipropargyl adipate was prepared by dissolving, in a round-bottomed flask under nitrogen, adipoyl chloride (3.6 g, 20 mmol, 1 equiv.) in THF (20 mL). The solution was cooled in an ice bath, and pyridine (4 mL) was added. Then, propargyl alcohol (2.2 g, 40 mmol, 2.2 equiv.) was slowly added to the mixture with vigorous stirring. As the ice bath melted, the reaction was slowly allowed to return to room temperature, and was left to stir overnight. The resulting material was fractionated between dichloromethane and 2M aqueous HCl. The organic phase was dried over sodium sulfate, evaporated, and subjected to chromatography over silica gel (elution with hexanes:ethyl acetate, 9:1, v:v) to yield the title compound as a clear oil (4.62 g; 96%). ¹H NMR (CDCl₃): δ=8.40 (t, J=5.0 Hz, 1H), 7.35 (s, 5H), 4.95 (s, 2H), 3.85 (m, 2H), 3.10 (s, 1H), 1.91 (m, 1H), 0.82 (d, J=6.6 Hz, 6H); ¹³C NMR (CDCl₃): δ=172.3, 77.7, 74.9, 51.8, 33.5, 24.1; IR (KBr, cm⁻¹): 2129 (C═C), 1739 (C═O), HRMS (ESI): m/z [M+Na]⁺ calculated=245.0790, [M+Na]⁺ found: 245.0787.

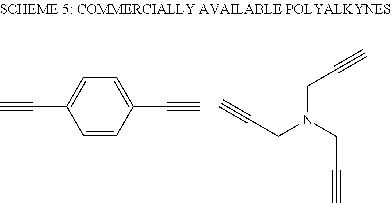

The thermal reaction between the polymeric polyazide silicone with acetylene-terminated disiloxane or dipropargyl adipate leads, in only 10 minutes at 90° C., to an almost colorless elastomer, very comparable in properties to the silicone elastomers obtained via hydrosilylation cure or RTV processes. Thus, efficient crosslinking is quickly achieved at a relatively low temperature, as illustrated in Scheme 6. Similar results were found with different polyalkyne crosslinkers, indicating that a wide range of composites materials can be obtained with this approach.

Moreover, it was found that by modulating the experimental conditions, such as by using a less volatile solvent (such as dioxane) or changing the stoichiometry between azido- and alkyne-moieties, different materials could be obtained (due to the amount of crosslinking), ranging from highly viscous polymers, soft elastomers, to strong, more rigid elastomers. It is also possible to form elastomers using non-stoichiometric mixtures such that residual alkynyl or azide groups are present and available for subsequent cycloaddition reactions. To demonstrate this principle, a film formed from an alkyne rich silicone elastomer was allowed to contract an azide rich silicone elastomer: the films adhered to each other once heated.

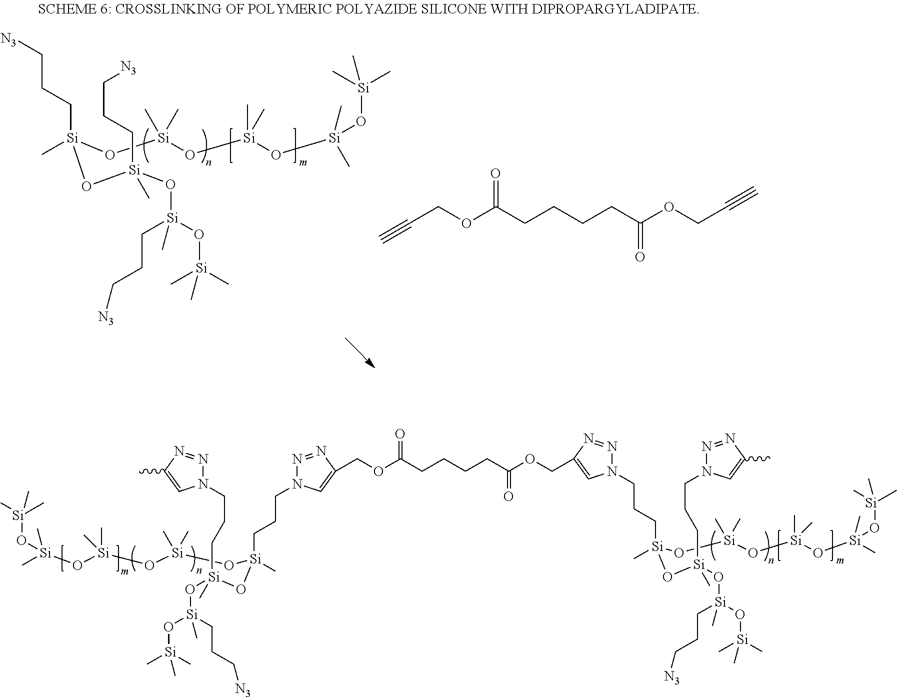

A general procedure for the preparation of monolithic elastomeric polysiloxanes follows: Polyazido-siloxane polymer (200 mg; 0.34 mmol of repeating unit) was weighed into 12 different 2 mL scintillation vials. Then, increasing amounts of crosslinker (bis-propynoic ester of bis(hydroxybutyl)tetramethyldisiloxane) were added to the azide, followed by 1 mL of dioxane. The sample numbers and the corresponding amounts of crosslinker are given in Table 4. The samples were then placed into an oven at 90° C. The types of product obtained after 3.5 h are provided in Table 4. Samples were heated at the same temperature for additional 3.5 hours: no changes were observed. Monolithic elastomers are efficiently prepared in a wide range of relative ratios between the azide and the crosslinker, which opens up new synthetic possibilities; residual azides can permit further derivatization of the rubbers.

In order to prove that samples were effectively crosslinked, they were soaked for 24 hours in THF: no dissolution nor significant weight loss occurred, indicating that rubbers were obtained through covalent chain-crosslinking. Comparable results were obtained with all the poly-alkynes (propargyl adipate, 1,4-diethynyl benzene, tripropargylamine) described earlier. It was also possible to perform the crosslinking in the absence of solvent: in these conditions, gelation was observed in only 10 min, at 90° C.

While the present disclosure has been described with reference to what are presently considered to be the preferred examples, it is to be understood that the disclosure is not limited to the disclosed examples. To the contrary, the disclosure is intended to cover various modifications and equivalent arrangements included within the spirit and scope of the appended claims.

### Example 7

### Synthesis of Mono- or Di-Propiolate Esters of Poly(Ethylene Oxide) Segments

A general procedure was adapted from an existing patent describing the synthesis of esters of acetylenic acids and polyhydric alcohols (Lee A. Miller and John M. Butler, U.S. Pat. No. 3,082,242).⁴⁰ A standard procedure is illustrated by the synthesis of monopropiolate-terminated PEO of molecular weight 750: in a 100 mL round-bottom flask were successively introduced monomethoxy-terminated PEO (15.0 g; 20.0 mmol), propiolic acid (2.80 g; 40.0 mmol), 65 mL of toluene and 10 Pasteur pipette drops of concentrated sulfuric acid. A magnetic stirbar was added, and the mixture was heated to reflux with azeotropic removal of water (Dean-Stark apparatus). The reaction was monitored by ¹H NMR, following the appearance of the methylenic esters protons at 4.27 ppm and integration versus the methoxy end group. Completion was reached in ca. 42 hours. The mixture was cooled, and treated with excess anhydrous potassium carbonate. Salts were filtered, and the filtrate was then treated with activated carbon for 2 h. The carbon black was filtered, and the volatiles removed in vacuo. This crude product was then passed through a short pad of neutral alumina, eluting with toluene, to afford the title compound as an almost colorless paste (15.10 g; 94% yield, MW of 704).

A similar procedure was used to prepare the di-propiolate esters of PEOs of molecular weight ˜1104, 2104 and 5104 (with starting PEOs of molecular weights ˜1000, 2000 and 5000, respectively).

### Example 8

### Synthesis of Mono- or Di-Azido-Terminated PEOs

There are numerous methods available in the literature for the preparation of azido-terminated PEOs. All methods rely on the activation of terminal hydroxyl groups via tosylation, mesylation, or chlorination, followed by nucleophilic displacement by an azide anion (for examples, see refs. in 41).

A typical procedure for the end-group modification of PEO (MW 2000) follows: the hydroxyl end groups of PEG were converted to azide groups (N₃-PEG-N₃) via the mesylate intermediate (CH₃SO₂O-PEG-OSO₂CH₃ or MsO-PEG-OMs).

(a) MsO-PEG-OMs: PEG (Acros) (Mn 1450 g/mol), 2.00 g, 2.76 mmol of OH) was dissolved in anhydrous dichloromethane (20 mL) containing triethylamine (Aldrich) (1.92 mL, 13.8 mmol). The flask was cooled to 0° C. in an ice bath, and 1.07 mL (13.8 mmol) of methanesulfonyl chloride (Acros) was added dropwise over 10 min under nitrogen. The mixture was stirred under nitrogen in the ice bath for about 1 h and then at room temperature for an additional 3.5 h. After the reaction, the mixture was washed twice with saturated sodium bicarbonate solution. The organic layer was collected, dried over magnesium sulfate, and precipitated twice into cold diethyl ether to obtain a pale yellow solid. Yield: 93%. ¹H NMR (D₂O) δ (ppm): 4.48 (4H, m, CH₂OMs), 3.87 (4H, m, CH₂CH₂OMs), 3.65-3.75 (128H, m, CH₂CH₂O), 3.25 (6H, s, CH₃SO₂O).

(b) N₃—PEG-N₃. MsO-PEG-OMs was dissolved in anhydrous DMF (Aldrich) and sodium azide (Acros) (1.1 equiv, based on the OMs end groups) was introduced. The mixture was stirred under nitrogen at 40° C. for 48 h. The product was precipitated two times in cold diethyl ether, with redissolution in dichloromethane after each precipitation. The solid precipitate was collected by vacuum filtration and dried in a vacuum oven. Yield: 70%. ¹H NMR (D₂O) δ (ppm): 3.65-3.75 (120H, m, CH₂CH₂O), 3.50 (4H, m, CH₂N₃).

In a like manner, azido-terminated PEOs of molecular weight 400, 1000 and 2000 were prepared.

### Example 9

### Synthesis of graft-(3-hydroxypropiolate esters)-polydimethylsiloxane copolymers

The synthetic pathway included a 3 step process, as shown in Scheme 7.

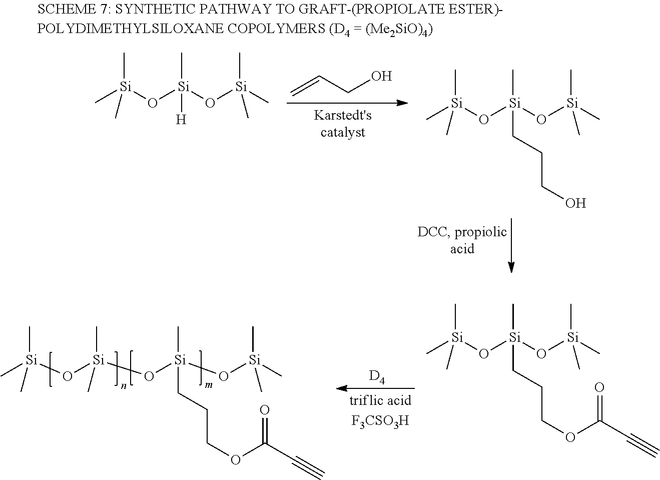

### (a) Hydrosilylation of bis(trimethylsiloxy)methylsilane

To bis(trimethylsiloxy)-methylsilane (11.126 g; 50 mmol) dissolved in 25 mL of dry THF was added allyl alcohol (4.356 g; 75 mmol) followed by Karstedt's catalyst (50 μL). The solution was stirred at room temperature until complete disappearance of the Si—H resonance (proton NMR). Volatiles were removed in vacuo, and the resulting crude product was used for the next step without further purification.

### (b) Propiolate ester of bis(trimethylsiloxy)-methyl(hydroxypropyl)silane

Small portions of dicyclohexylcarbodiimide (DCC, 4.13 g, 20 mmol) were added to a cooled (−40° C.; dry ice in acetone) solution of bis(trimethylsiloxy)methyl(hydroxypropyl)silane (5.612 g, 20 mmol) and propiolic acid (1.75 g, 25 mmol) in dichloromethane (50 mL), after which was added a catalytic amount of dimethylaminopyridine (DMAP, 0.024 g, 0.2 mmol). The reaction was stirred at a temperature below −20° C. for 20 h. Then, dry ether was added (100 mL), and the solution was filtered. Following evaporation of the solvents, the crude product was purified by silica gel chromatography (from 95/5 to 75/25 hexanes/ethyl acetate as eluent) to yield 3.09 g (81%) of the dipropionic ester product.

### (c) Equilibration Reaction of 1 with Octamethylcyclotetrasiloxane (D₄): Synthesis of Graft-Copolymers

Octamethylcyclotetrasiloxane (D₄, 3.00 g, 100 mmol) and the propiolate ester of bis(trimethylsiloxy)methyl(hydroxypropyl)silane (0.50 g, 1.31 mmol) were placed in a 50 mL round-bottomed flask fitted with a drying tube. The mixture was agitated with a magnetic stirrer, and then triflic acid (200 μL) was added. The mixture was stirred for 1 day at room temperature after which was added magnesium oxide (0.40 g) followed by dry hexanes (40 mL). The slurry was stirred for 1 h, then filtered through a short pad of Celite. Volatiles were removed in vacuo to yield 3.10 g of crude product. This crude product was purified by Kugelrohr distillation (2 h at 120° C., 0.5 h at 140° C.) to yield 2.28 g of a clear transparent oil. ¹H NMR indicates that the average repeating unit was constituted of 21 dimethylsiloxane units for every methyl-hydroxypropiolate ester unit (relative integration of the 2H (alkynyl protons at 2.88 ppm) and 4H(CH₂ ester peak at 4.18 ppm) versus 126 for dimethylsiloxane (SiCH₃ at 0.03 ppm)), which corresponds to an average molecular weight of 1790 for the repeating unit.

### Example 10

### Synthesis of APCNs

Method A

The general procedure is illustrated by the cross-linking reaction between propiolate-ester terminated PEO (Initial MW of 600, MW=704 after di-esterification) and poly(methylazido-propyl)-co-(dimethylsiloxane) (with an azide to alkyne ratio of 1): in a 5 mL scintillation vial was introduced poly(methylazidopropyl)-co-(dimethylsiloxane) (0.200 g; 0.39 mmol of repeating unit), followed by dipropiolate ester PEO (0.137 g; 0.195 mmol). Then, chloroform was added until a single transparent and homogeneous phase was obtained. A magnetic stir bar was added, the vial was capped, and placed in a heating bath set at 50° C. for 2 h under stirring. The magnetic bar was removed, and the vial was allowed to cool to room temperature. At this stage, a pre-curing process has already linked some PEO units to the graft-azidosiloxane. Final curing was performed in the capped vial for one more day, then in the uncapped vial, which allows slow evaporation of chloroform and final cure to occur. The resulting cross-linked amphiphilic network presented itself as a colorless transparent, crack-free monolithic elastomer. The hydrophobichydrophilic mass ratio of this elastomer was calculated to be 1.46.

Similar procedures performed with alkyne-terminated PEOs of molecular weights of ˜1104, 2104 and 5104, respectively, to yield amphiphilic polymeric co-networks with hydrophobichydrophilic mass ratios of 0.93, 0.41 and 0.20, respectively. As the curing time was found to increase with the molecular weight of the dialkyne-terminated PEOs, it is possible to shorten the process by finalizing the cure at 50° C. or more elevated temperature.

By simply varying the molecular weight of the di-alkyne PEO, it is possible to prepare amphiphilic co-networks of various hydrophobic to hydrophilic ratios, from highly hydrophobic co-networks to almost completely hydrophilic materials.

Moreover, the hardness of those co-networks can also be easily tuned, by changing the number of crosslink units: in that case, a fraction of dialkyne-terminated PEO is replaced by a mono-alkyne terminated PEO (such as mono-propiolate ester of monomethoxy-terminated PEO of molecular weight 750).

Method B

The general procedure is illustrated by the cross-linking reaction between azido-terminated PEO (MW of 400) and a graft(poly(methyl(hydroxypropiolate ester)siloxane)-co-(dimethylsiloxane) (with an azide to alkyne ratio of 1): in a 5 mL scintillation vial was introduced the azido-terminated PEO (0.200 g; 0.5 mmol), followed by the graft-poly-alkynesiloxane (0.137 g; 0.195 mmol). Then, chloroform was added until a single transparent and homogeneous phase was obtained. A magnetic stir bar was added, the vial was capped, and placed in a heating bath set at 50° C. for 2 h under stirring. The magnetic bar was removed, and the vial was allowed to cool to room temperature. At this stage, a pre-curing process has already linked some PEO units to the alkynyl-siloxane. Final curing was performed in the capped vial for one more day, then in the uncapped vial, which allows slow evaporation of chloroform and final cure to occur. The resulting cross-linked amphiphilic network present itself as a clear transparent, crack-free monolithic elastomer. The hydrophobic/hydrophilic mass ratio of this elastomer was calculated to be 1.46.

Similar procedures performed with azide-terminated PEOs of molecular weights ˜1000 and ˜2000 yielded amphiphilic polymeric co-networks with hydrophobic/hydrophilic mass ratios of 0.93 and 0.41, respectively. As the curing time was found to increase with the molecular weight of the azide-terminated PEOs, it is possible to shorten the process by finalizing the cure at 50° C. or more elevated temperature.

By simply varying the molecular weight of the di-alkyne PEO, it is possible to prepare amphiphilic co-networks of various hydrophobic to hydrophilic ratios, from highly hydrophobic co-networks to almost completely hydrophilic materials. Similarly, by varying the ratio between D₄ and the starting trisiloxane ester, the grafting density of alkyne on the polysiloxane can be finely tuned, which allows the introduction of more or fewer reactive sites on the polymeric chain (and thus requires more or less azidoPEOs to be added in order to achieve a 1 to 1 ratio between alkyne- and azide-moieties). Moreover, the hardness of those co-networks can also be easily tuned, by changing the number of crosslink units: in that case, a fraction of diazide-terminated PEO is replaced by a mono-azide terminated PEO (such as mono-azido derivative of monomethoxy-terminated PEO of molecular weight 750).

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE SPECIFICATION

1. M. A. Brook, Silicon in Organic, Organometallic, and Polymer Chemistry, Wiley, New York, 2000.
2. D. J. Guo, H. M. Han, W. Jing, S. J. Xiao and Z. D. Dai, Colloid Surf. A-Physicochem. Eng. Asp., 2007, 308, 129-135.
3. R. Murthy, C. D. Cox, M. S. Hahn and M. A. Grunlan, Biomacromolecules, 2007, 8, 3244-3252.
4. R. Wagner, L. Richter, R. Wersig, G. Schmaucks, B. Weiland, J. Weissmuller and J. Reiners, Appl. Organomet. Chem., 1996, 10, 421-435.
5. V. v. Braunmuehl, G. Jonas and R. Stadler, Macromolecules, 1995, 28, 17-24.
6. R. Wagner, L. Richter, B. Weiland, J. Reiners and J. Weissmuller, Appl. Organomet. Chem., 1996, 10, 437-450.
7. V. Bartzokao, M. A. Brook and M. R. McDermott, Langmuir, 1998, 14, 1887-1891.
8. V. Bartzoka, M. A. Brook and M. R. McDermott, Langmuir, 1998, 14, 1892-1898.
9. G. Hu, F. J. LaRonde and M. A. Brook, Silicon Chem, 2002, 1, 215-222.
10. R. F. Service, Science, 2008, 320, 868-869.
11. H. C. Kolb, M. G. Finn and K. B. Sharpless, Angewandte Chemie International Edition, 2001, 40, 2004—F.
12. K. B. Sharpless, V. Fokin, V. A. Rostovtsev, L. Green and F. Himo, in U.S. Pat. No. 7,375,234, The Scripps Research Institute, 2008.
13. F. Santoyo-Gonzales and F. Hernandez-Mateo, in Topics in Heterocyclic Chemistry, ed. E. S. H. El Ashry, Springer-Verlag, Berlin, 2007, pp. 133-177.
14. B. C. Englert, S. Bakbak and U. H. F. Bunz, Macromolecules, 2005, 38, 5868-5877.
15. (a) S. Halila, M. Manguian, S. Fort, S. Cottaz, T. Hamaide, E. Fleury and H. Driguez, Macromol. Chem. Phys., 2008, 209, 1282-1290; (b) E. Fleury, S. Halila, H. Driguez, S. Cottaz, T. Hamaide and S. Fort, PCT Patent Application Publication No. WO/2007/132000, Nov. 22, 2007.
16. Y. L. Angell and K. Burgess, Chemical Society Reviews, 2007, 36, 1674-1689.
17. C. D. Smith, I. R. Baxendale, S. Lanners, J. J. Hayward, S. C. Smith and S. V. Ley, Organic & Biomolecular Chemistry, 2007, 5, 1559-1561.
18. J. H. Jung, Y. G. Lim, K. H. Lee and B. T. Koo, Tetrahedron Lett., 2007, 48, 6442-6448.
19. L. A. Inverarity, R. F. H. Viguier, P. Cohen and A. N. Hulme, Bioconjugate Chem., 2007, 18, 1593-1603.
20. L. Marmuse, S. A. Nepogodiev and R. A. Field, Organic & Biomolecular Chemistry, 2005, 3, 2225-2227.
21. P. F. Tankam, R. Muller, P. Mischnick and H. Hopf, Carbohydrate Research, 2007, 342, 2049-2060.
22. J. V. dos Anjos, D. Sinou, S. J. de Melo and R. M. Srivastava, Synthesis, 2007, 2647-2652.
23. X. H. He, L. Y. Liang, M. R. Xie, Y. Q. Zhang, S. L. Lin and D. Y. Yan, Macromol. Chem. Phys., 2007, 208, 1797-1802.
24. Y. Li, J. W. Yang and B. C. Benicewicz, Journal of Polymer Science Part a—Polymer Chemistry, 2007, 45, 4300-4308.
25. G. Molteni, C. L. Bianchi, G. Marinoni, N. Santo and A. Ponti, New J. Chem., 2006, 30, 1137-1139.
26. J. D. Umpleby, in Eur. Pat. Appl., EP 295811 A1 19881221 EP 88-305040 19880602, British Petroleum Co. PLC, Britain, 1988.
27. J. E. Moses and A. D. Moorhouse, Chemical Society Reviews, 2007, 36, 1249-1262.
28. M. R. Whittaker, C. N. Urbani and M. J. Monteiro, J. Am. Chem. Soc., 2006, 128, 11360-11361.
29. T. Tsunoda, T. Yamaoka, K. Ozeki, M. Hatanaka and Y. Funahashi, in Jpn. Kokai Tokkyo Koho JP 54069197 19790602 Japan, 1979.
30. A. Karl and W. Buder, in Eur. Pat. Appl. EP 50768 A2 19820505 Application: EP 81-108108 19811009, Degussa A.-G., Germany, 1982.
31. S. Brase, C. Gil, K. Knepper and V. Zimmermann, Angew. Chem.-Int. Edit., 2005, 44, 5188-5240.
33. A. Komaraiah, K. Ramakrishna, B. Sailu and P. S. N. Reddy, Arkivoc, 2007, 110-116.
34. Z. M. Li, T. S. Seo and J. Y. Ju, Tetrahedron Lett., 2004, 45, 3143-3146.
36. D. H. Ess, G. O. Jones and K. N. Houk, Advanced Synthesis & Catalysis, 2006, 348, 2337-2361.
37. E. H. Ryu and Y. Zhao, Organic Letters, 2005, 7, 1035-1037.
38. G. Z. Gao, F. Sanda and T. Masuda, Macromolecules, 2003, 36, 3932-3937.
39. Gonzaga, F.; Yu, G.; Brook, M. A., Chem. Commun. 2009, 1730-1732.
40. Lee A. Miller and John M. Butler, U.S. Pat. No. 3,082,242
41. Polizzotti, B. D.; Fairbanks, B. D.; Anseth, K. S. Biomacromolecules, 2008, 9, 1084-1087; Malkoch, M.; Vestberg, R.; Gupta, N.; Mespouille, L.; Dubois, P.; Mason, A. F.; Hedrick, J. L.; Liao, Q.; Frank, C. W.; Kingsbury, K.; Hawker, C. J. Chem. Commun. 2006, 2774-2776).

TABLE 1
THERMAL CLICK REACTIONS OF BAPTMDS

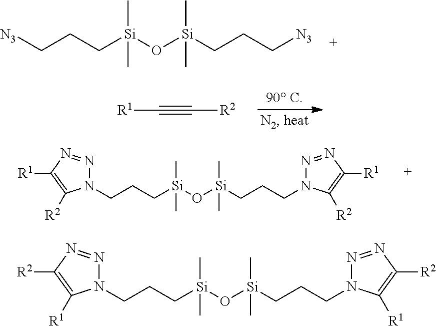

| Entry | Starting Alkyne | R¹ | R² | Yield* |
|---|---|---|---|---|
| 1 | Propargyl alcohol | H or CH₂OH | H or CH₂OH | 100% |
| 2 | Phenylacetylene | H or Ph | H or Ph | 100% |

*While the ratio of regio isomers was shown to be 1:1, the distribution of symmetrical (R¹ terminal), symmetrical (R² terminal) and the mixed compounds in which one triazole has R¹ external and the other has R² external was not determined.

TABLE 2
COPPER-CATALYZED CLICK LIGATIONS OF ALKYNES WITH ALKYNES

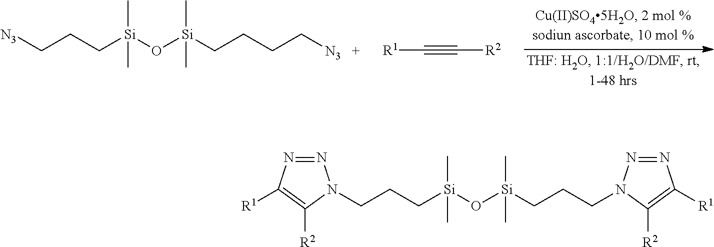

| Entry | 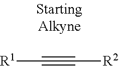 | Product | Isolated Yield |
|---|---|---|---|
| 1 | 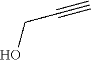 | 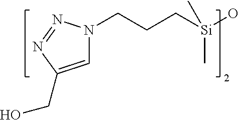 | 94% |
| 2 | 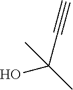 | 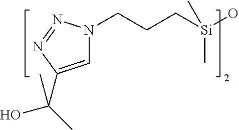 | 95% |
| 3 | 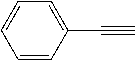 | 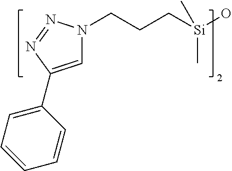 | 96% |
| 4 | 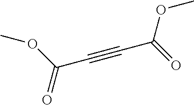 | 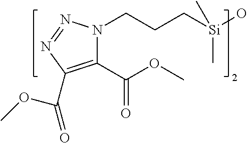 | 92% |
| 5 | 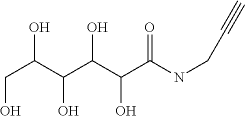 | 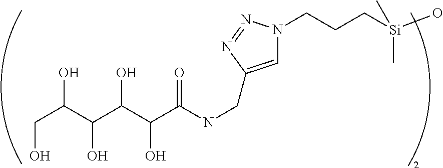 | 94% |
| 6 | 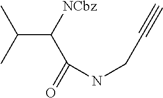 | 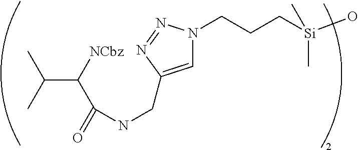 | 100% |
| 7 | 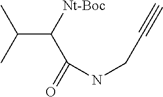 | 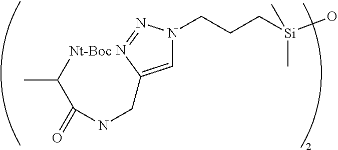 | 95% |

TABLE 3
THERMAL AND COPPER-CATALYZED EXAMPLES OF CLICK
REACTIONS OF POLY(AZIDOPROPYL) SILICONE

| | Cyclo- | | | |
|---|---|---|---|---|
| | addi- | | | Iso- |
| En- | tion | Starting | | lated |
| try | type | Alkyne | Product | Yield |
| 1 | Ther- mal | 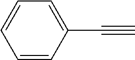 | 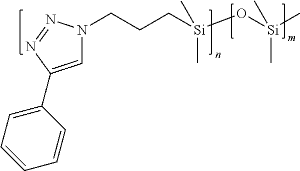 | 100% |
| 2 | Copper cata- lyzed | 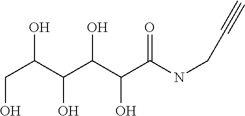 | 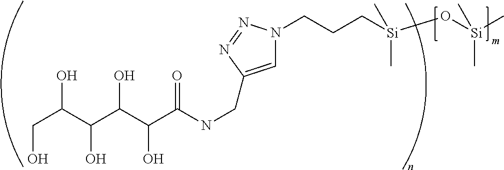 | 84% |

TABLE 4
OUTCOMES OF THERMAL CLICK CROSSLINKING REACTIONS
AFTER 3.5 HOURS

| | Amount | | | | |
|---|---|---|---|---|---|
| | of Azide | Amount | Alkyne | Estimated | |
| | (By ¹H | of | groups | molar | Type |
| Sample | NMR) | crosslinker | concentration | ratio | of |
| Number | (mM) | (mg) | (mM) | (azide/alkyne) | product |
| 1 | 0.39 | 5 | 0.026 | 15.0 | Viscous |
| | | | | | oil |
| 2 | 0.39 | 10 | 0.052 | 7.50 | Viscous |
| | | | | | oil |
| 3 | 0.39 | 20 | 0.104 | 3.75 | Monolithic |
| | | | | | elastomer |
| 4 | 0.39 | 30 | 0.157 | 2.50 | Monolithic |
| | | | | | elastomer |
| 5 | 0.39 | 50 | 0.260 | 1.50 | Monolithic |
| | | | | | elastomer |
| 6 | 0.39 | 75 | 0.390 | 1.00 | Monolithic |
| | | | | | elastomer |
| 7 | 0.39 | 100 | 0.520 | 0.75 | Monolithic |
| | | | | | elastomer |
| 8 | 0.39 | 125 | 0.650 | 0.60 | Monolithic |
| | | | | | elastomer |
| 9 | 0.39 | 150 | 0.780 | 0.50 | Monolithic |
| | | | | | elastomer |
| 10 | 0.39 | 200 | 1.040 | 0.38 | Monolithic |
| | | | | | elastomer |
| 11 | 0.39 | 400 | 2.080 | 0.19 | Viscous |
| | | | | | gel |
| 12 | 0.39 | 800 | 4.160 | 0.09 | Viscous |
| | | | | | oil |

1. A method for preparing organosilicon-containing triazoles comprising reacting:
(i) an organosilicon-containing compound comprising at least one azide group with a compound comprising at least one alkyne group; or
(ii) an organosilicon-containing compound comprising at least one alkyne group with a compound comprising at least one azide group
under thermal reaction conditions in the absence of a catalyst.

2. The method of claim 1 comprising reacting an organosilicon-containing compound comprising at least one azide group with a compound comprising at least one alkyne group under thermal reaction conditions in the absence of a catalyst.

3. The method of claim 1, wherein the organosilicon-containing azide is a silane wherein the silicon is separated from the azide group by 1-20 carbon atoms.

4. The method of claim 1, wherein the at least one alkyne group is an electron deficient alkyne.

5. The method of claim 4, wherein the alkyne is substituted with one or two electron-withdrawing groups selected from C(Y)—Z—R^{a}, wherein R^{a} is an organic grouping, a halogen selected from I, Cl, Br and F, Y is O, N, NH or S and Z is O, S, N, NH, H, or a bond.

6. The method of claim 1, wherein the azide and the alkyne are located on the same molecule and the reaction results in the intramolecular and/or intermolecular formation of a triazole.

7. A method for preparing a compound of formula (Ia) and/or (Ib) 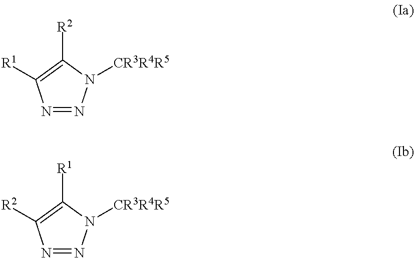
the method comprising reacting a compound of the formula (II) with a compound of the formula (III):
R³R⁴R⁵C—N₃ (II)
R¹—═—R² (III)
wherein R¹, R², R³, R⁴ and R⁵ are, independently, any organic grouping and at least one of R¹, R², R³, R⁴ and R⁵ comprises at least one silicon atom,
under thermal reaction conditions in the absence of a catalyst.

8. A method for preparing organosilicon-containing polymers containing one or more triazoles comprising reacting:
an organosilicon-containing polymer comprising at least one azide group with a compound comprising at least one alkyne group; or
an organosilicon-containing polymer comprising at least one alkyne group with a compound comprising at least one azide group,
under thermal reaction conditions in the absence of a catalyst.

9. The method of claim 8 comprising reacting an organosilicon-containing polymer comprising at least one azide group with a compound comprising at least one alkyne group under thermal reaction conditions in the absence of a catalyst.

10. The method of claim 8, wherein a mono-, di-, oligo- or polyazidosilicone is reacted with a di-, oligo- or polyalkynyl-substituted compound, or a mono-, di-, oligo- or polyalkynylsilicone is reacted with a di-, oligo- or polyazido-substituted compound and said reaction forms crosslinks between polymers.

11. A method for preparing a silicone polymer comprised of monomer units of the formula (IVa) and (IVb) and/or (IVc): 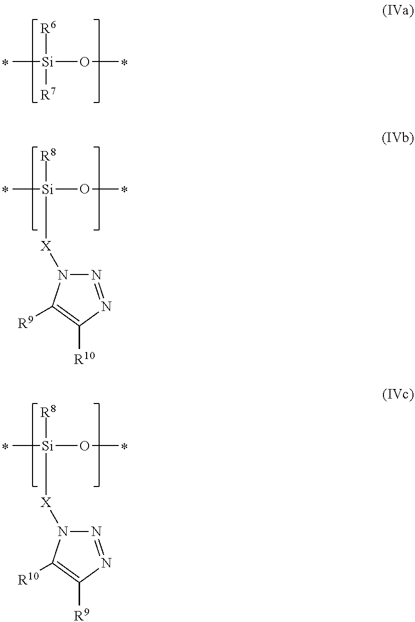
the method comprising reacting a silicone polymer comprised of monomer units of the formulae (IVa) and (V) with a compound of the formula (VI): 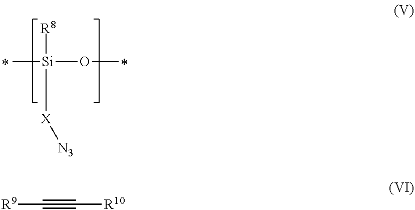
wherein R⁶, R⁷, R⁸, R⁹ and R¹⁰ are, independently, any organic grouping;
X is selected from, C₁₋₂₀alkylene, which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping,
under thermal reaction conditions in the absence of a catalyst.

12. A method for preparing a silicone polymer comprised of monomer units of the formulae (VIIa) and (VIIb) and/or (VIIc): 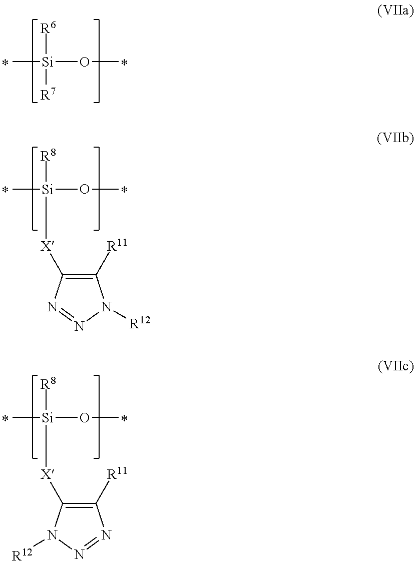
the method comprising reacting a silicone polymer comprised of monomer units of the formulae (VIIa) and (VIII) with a compound of the formula (IX): 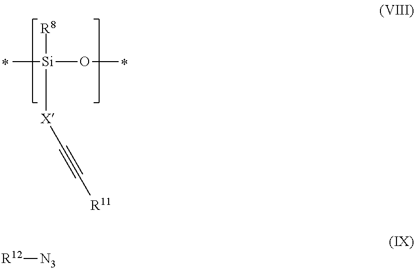
wherein R⁶, R⁷, R⁸, R¹¹ and R¹² are, independently, any organic grouping;
X′ is selected from, C₀₋₂₀alkylene, which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping,
under thermal reaction conditions in the absence of a catalyst.

13. The method of claim 11, wherein R⁹ and/or R¹⁰ in the compounds of Formula (VI) comprise one or more alkynyl groups.

14. The method of claim 12, wherein R¹² in the compounds of Formula (IX) comprise one or more azide groups.

15. The method of claim 13 wherein the reaction forms crosslinks between polymers.

16. The method of claim 15, wherein the polymers are films.

17. A method for crosslinking two or more polymeric silicon films at a desired time comprising placing two or more polymeric silicon films having one or more azide groups into contact with each other along with a crosslinking agent comprising one or more alkynes, or two or more polymeric silicon films having one or more alkyne groups into contact each other along with a crosslinking agent comprising one or more azide groups, or a polymeric silicon film comprising one or more alkyne groups and a polymeric silicon film containing one or more azide groups, and when crosslinking is desired, heating the films to a temperature to affect the reaction between the one or more azides with the one or more alkynes to form one or more triazoles as the crosslinks between the films.

18. The method of claim 17, wherein the polymeric silicon film is a silicone.

19. The method of claim 1, wherein the organosilicon-containing compound is an organosilicon-containing polymer and the compound comprising at least one alkyne group is a hydrophilic polymer and the compound comprising at least one azide group is a hydrophilic polymer.

20. The method of claim 7, wherein the compounds of formula II and the compounds of formula III are polymers with the silicon-containing polymer being hydrophobic in character and the other polymer being a hydrophilic polymer.

21. The method of claim 11, wherein the compounds of formula V and the compounds of formula VI, are polymers, with the silicon-containing polymer being hydrophobic in character and the other polymer being a hydrophilic polymer.

22. The method of claim 8 wherein the hydrophilic polymer is an alkynyl or azido derivative of an anionic, a neutral or a cationic hydrophilic polymer.

23. The method of claim 22, wherein the hydrophilic polymer is selected from an alkynyl or azido derivative of poly(acrylamide), poly(acrylamide-co-acrylic acid) and their total or partial salts, poly(acrylamide-co-diallyldimethylammonium chloride), poly(2-acrylamido-2-methyl-1-propanesulfonic acid), poly(2-acrylamido-2-methyl-1-propanesulfonic acid-co-acrylonitrile), poly(acrylic acid) and its partial or total salts, poly(acrylic acid-co-maleic acid), poly(acrylic acid (partial sodium salt)-graft-poly(ethylene oxide), poly(allylamine), poly(allylamine hydrochloride), 1-[N-[poly(3-allyloxy-2-hydroxypropyl)]-2-aminoethyl]-2-imidazolidinone, poly(aniline) (emeraldine salt), poly(3,3′,4,4′-biphenyltetracarboxylic dianhydride-co-1,4-phenylenediamine), poly[bis(2-chloroethyl)ether-alt-1,3-bis[3-(dimethylamino)propyl]urea](quaternized), poly[1,4-bis(hydroxyethyl)terephthalate-alt-ethyloxyphosphate], poly[1,4-bis(hydroxyethyl)terephthalate-alt-ethyloxyphosphate]-co-1,4-bis(hydroxyethyl)-co-terephtalate, poly(bis(4-sulfophenoxy)phosphazene), polybutadiene-epoxy, hydroxy functionalized, poly(butyl acrylate), poly(tert-butyl acrylate-co-ethyl acrylate-co-methacrylic acid), poly(1,4-butylene adipate), poly(1,4-butylene succinate), poly(butyl methacrylate), poly(tert-butyl methacrylate), poly(tert-butyl methacrylate-co-glycidyl methacrylate), poly(butyl methacrylate-co-isobutyl methacrylate), poly(butyl methacrylate-co-methyl methacrylate), polycaprolactone, polycaprolactonediol, poly(caprolactone-block-polytetrahydrofuran-block-polycaprolactone), polycaprolactonetriol, poly((o-cresyl glycidylether)-co-formaldehyde), poly(9,9-di-(3′,7′-dimethyloctyl)fluoren-2,7-yleneethynyl-ene), poly(2,5-didodecylphenylene-1,4-ethynylene), poly[di(ethyleneglycol)adipate], polyfluorene and its 9,9-substituted polymers and copolymers, poly(dimethylamine-co-epichlorohydrin-co-ethylenediamine), poly(2-dimethylamino)ethyl methacrylate)methylchloride quaternary salt, polydimethylsiloxane and its co-, graft-, block, polymers and copolymers, poly(dimethylsiloxane)-graft-polyacrylates, poly(epoxysuccinic acid,) polyester-block-polyether diol, poly(vinylphosphonic acid), poly(2-ethylacrylic acid), poly(ethylene glycol), poly(ethylene glycol)-block-poly(caprolactone)methyl ether, poly(ethylene glycol)-block-polylactide methyl ether, poly(ethylene glycol)-block-poly(propylene glycol)-block-poly(ethylene glycol), poly(ethyleneimine), poly(ethylene-alt-maleic anhydride), polyethylene-graft-maleic anhydride, poly(ethylene-co-methacrylic acid) and its total and partial salts, poly(ethylene-co-methyl acrylate-co-glycidyl methacrylate), poly(ethylene oxide), poly(ethylene oxide)-4-arms, poly(ethylene oxide)-harms, and their carboxylic acid, hydroxyl, and thiol-terminated analogs, poly(ethylene oxide)-block-polycaprolactone, 4arms, poly(ethylene oxide)-block-polylactide, 4arms, poly(ethylene succinate), polyethyleneimine, branched, polyethyleneimine-ethoxylated, poly(2-ethyl-2-oxazoline), polyglycolic acid, polyglycolide, poly(3-hydroxybutyric acid), poly(3-hydroxybutyric acid-co-3-hydroxyvaleric acid), poly(2-hydroxyethyl methacrylate), poly(isobutylene-co-maleic acid) and its sodium salts, poly(isobutylene-co-maleic acid, ammonium salt)-co-(isobutylene-alt-maleic anhydride), poly(N-isopropylacrylamide), polylactic acid, polylactide, poly(lactide-co-caprolactone), poly(lactide-co-ethyleneglycol-co-ethyloxyphosphate), poly(lactide-co-glycolide), polylactide-block-poly(ethyleneglycol)-block-polylactide, poly(methylvinylether-alt-maleic anhydride), poly((phenylglycidyl ether)-co-formaldehyde), poly(2-propylacrylic acid), poly(propylene glycol), poly(propylene glycol)-block-poly(ethylene glycol)-block-poly (propylene glycol), polypyrrole, poly(sodium 4-styrenesulfonate), poly(styrene)-block-poly(acrylic acid), poly(4-styrenesulfonic acid) and its salts, poly(4-styrenesulfonic acid-co-maleic acid) and its salts, poly(tetrahydrofuran), poly(thiophene)polyurethane, poly(vinyl alcohol), poly(vinyl chloride), poly(vinyl acetate), poly(vinylphosphonic acid), poly(4-vinylpyridine), polyvinylpyrrolidone, poly(vinylsulfate) and its salts and polyvinylsulfonic acid.

24. A compound prepared using the method of claim 1.

25. A compound of formula (Ia) and/or (Ib): 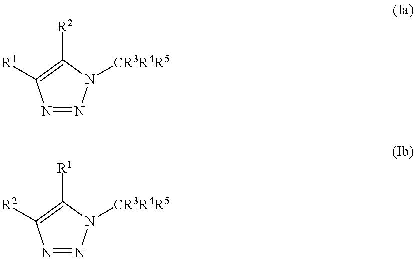
wherein R¹, R², R³, R⁴ and R⁵ are, independently, any organic grouping and at least one of R¹, R², R³, R⁴ and R⁵ comprises at least one silicon atom.

26. A silicone polymer comprised of repeating monomer units of the formulae (IVa) and (IVb) and/or (IVc): 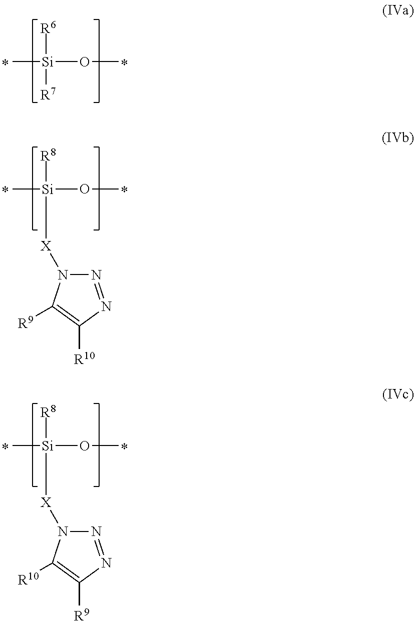
wherein R⁶, R⁷, R⁸, R⁹ and R¹⁰ are, independently, any organic grouping;
X is selected from, C₁₋₂₀alkylene, which is optionally substituted with one or more organic groupings and/or in which one or more carbon atoms is optionally replaced with an arylene, a heteroatom and/or —C(Q)- wherein Q is a heteroatom; and
* represents a linkage to another monomer unit or to a terminal grouping.

27. A silicone polymer comprised of repeating monomer units of the formulae (VIIa) and (VIIb) and/or (VIIc): 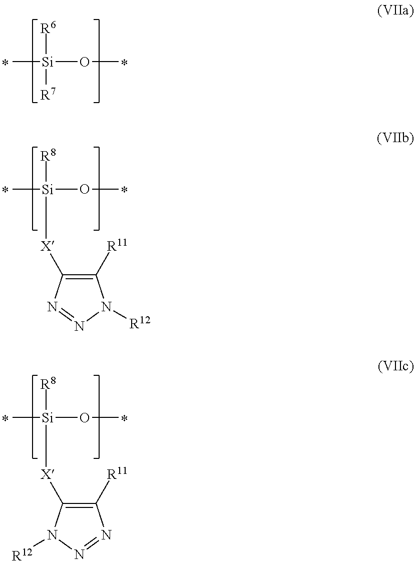
wherein R⁶, R⁷, R⁸, R¹¹ and R¹² are, independently, any organic grouping;
X′ is selected from, C₀₋₂₀alkylene which is optionally substituted with one or more organic groupings and/or in which one or more carbon atoms is optionally replaced with an arylene, a heteroatom and/or C(Q) wherein Q is a heteroatom; and
* represents a linkage to another monomer unit or to a terminal grouping.
